(19) United States
(12) Patent Application Publication
(10) Pub. No.: US 2023/0163274 A1
(43) Pub. Date: May 25, 2023

(54) COMPOSITE PARTICLE AND METHOD OF FORMING SAME

(71) Applicant: ANTEO ENERGY TECHNOLOGY PTY LIMITED, Eight Mile Plains, Queensland (AU)

(72) Inventors: Khadija ALSABAWI, Redland Bay, Queensland (AU); Kai-Anders HANSEN, Runcorn, Queensland (AU); Chang-Yi HUANG, Calamvale, Queensland (AU); Nobuyoshi Joe MAEJI, Stones Corner, Queensland (AU); Manuel Christoph WIESER, Rochedale South, Queensland (AU)

(73) Assignee: ANTEO ENERGY TECHNOLOGY PTY LIMITED, Eight Mile Plains, Queensland (AU)

(21) Appl. No.: 17/917,741

(22) PCT Filed: Apr. 8, 2021
(86) PCT No.: PCT/AU2021/050322

§ 371 Date: Oct. 7, 2022

(30) Foreign Application Priority Data
Apr. 8, 2020 (AU) 2020901116

(51) Int. Cl. H01M 4/36; H01M 4/62; H01M 4/04; H01M 10/0525; H01M 4/60

(52) U.S. Cl. CPC H01M 4/364; H01M 4/622; H01M 4/0471; H01M 10/0525; H01M 4/60

(57) ABSTRACT

The present invention relates to a method of forming a composite particle, a composite particle precursor formulation, a composite particle, and a composite material comprising a plurality of composite particles. The method of forming a composite particle may include the step of: contacting an active material particle, a modified oligomeric metal coordination complex, and at least one polymer, to thereby form a composite particle.

### FIELD OF THE INVENTION

The invention relates to, inter alia, a method of forming a composite particle, a composite particle precursor formulation, a composite particle, and a composite material comprising a plurality of composite particles. In one embodiment, the invention relates to forming composite particles comprising particles which are controllably coated and/or interconnected within a polymeric network.

### BACKGROUND OF THE INVENTION

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

Particles, of various shapes and sizes are a staple of many industrial processes. For example, particles, commonly called “resins”, are used as ion exchangers to remove or exchange certain ions commonly encountered in applications including water treatment. There is a wide range of such resins, which are based on the polymerization of an appropriate monomer with a suitable cross-linking agent, such as styrene with divinylbenzene. Depending on the ratio of cross-linker to monomer, different resin types for different applications are produced. Low levels of cross-linkers can result in gel/microporous type resins which are highly flexible while increasing amounts of cross-linker provide more rigid macroporous/macroreticular resins. In the latter scenario the addition of porogens allows for formation of pores or channels of varying sizes, thereby leading to resins of different elasticity, strengths, surface area, and other desirable attributes.

A further elaboration is those incorporating smaller particles within a larger composite particle. One example of such a composite particle is the use of ferric oxide nanoparticles to form larger magnetic particles for diagnostic applications. There are many similar examples utilising different metal nanoparticles, such as gold, silver, and copper, into larger “aggregated” particles for antimicrobial activity, sensor applications, catalysts and many other uses. It is often the case that such nanoparticles are embedded within a polymer matrix and not actively bound within or to the matrix. If controlled release of the nanoparticles is desired, then the inevitable leaching from the larger composite structure is desirable but there are many applications where any leaching is detrimental. If these composite particles are also required to be porous, then the leaching problem is greatly magnified.

One application where such porous composite particles are useful is in the development of silicon anodes. Some key challenges with the use of silicon based materials in forming anodes is their poor ionic/electronic conductivity and the large volume changes experienced due to lithium ion intercalation and deintercalation during cycling, which leads to structural damage and subsequent loss of performance. The use of smaller silicon nanoparticles, as opposed to larger micron-sized particles, can assist in mitigating against such problems but large-scale use of silicon nanoparticles has been hindered by concerns over handling during manufacture, achieving uniform dispersion and safety considerations. Several approaches have been proposed to address these difficulties and some have involved the production of aggregated silicon structures.

Within aggregate structures there can be benefits to incorporating porosity to accommodate silicon swelling and so reduce stress fracturing of the composite particle. Prior art approaches include battery electrode compositions comprising composite particles with a porous, electrically conductive scaffolding matrix within which the silicon material is disposed such as disclosed in International publication no. WO2014031929. Such composite particles can also include a permeable shell around the core structures as disclosed in International publication no. WO2013192205. Such aggregate structures have value in energy storage and generation processes as well as many other applications.

However, the production of such porous composite particles is not a trivial process. A non-exhaustive list of complicating issues includes poor understanding of phase transition of the materials involved, the difficulty of isolating the material from the medium, undesired composite particle aggregation, and particle uniformity and appropriate control over porosity. There is therefore a need for additional approaches to forming suitable composite particles which at least ameliorates some of these problems and provides for composite particles useful in one or more commercial applications.

### SUMMARY OF THE INVENTION

In a first aspect, although not necessarily the broadest aspect, the invention provides a method of forming a composite particle including the step of: contacting an active material particle, a modified oligomeric metal coordination complex, and at least one polymer, to thereby form a composite particle.

In one embodiment, the first aspect may provide a method of forming a composite particle including the steps of:
(i) mixing an active material particle, a modified oligomeric metal coordination complex, at least one polymer and a liquid carrier to provide a mixed solution; and
(ii) at least partially removing the liquid carrier from the mixed solution;
   to thereby form a composite particle.

In one embodiment of the first aspect, there is provided a method of forming a composite particle including the steps of:
(i) providing a plurality of activated particles comprising active material particles at least partially coated with a modified oligomeric metal coordination complex; and
(ii) contacting the plurality of activated particles with at least one polymer capable of forming coordinate bonds with the modified oligomeric metal coordination complex,

to thereby form a composite particle.

In a second aspect, there is provided a composite particle precursor formulation comprising: an active material particle, an oligomeric metal coordination complex, at least one polymer and a liquid carrier.

In one embodiment, of the second aspect, the liquid carrier comprises at least one capping group.

In one embodiment of the second aspect, there is provided a composite particle precursor formulation comprising:
(i) a plurality of activated particles comprising active material particles at least partially coated with a modified oligomeric metal coordination complex;
(ii) at least one polymer capable of forming coordinate bonds with the modified oligomeric metal coordination complex; and
(iii) a liquid carrier in which the plurality of activated particles and at least one polymer are located.

In a third aspect, there is provided a composite particle comprising a plurality of active material particles, a polymeric network and a plurality of oligomeric metal coordination complexes coordinately bonded to the active material particles and the polymeric network, wherein the majority of at least one active material particle is linked to the polymeric network by one or more of the plurality of oligomeric metal coordination complexes.

In a fourth aspect, there is provided a composite material comprising a plurality of composite particles of the third aspect and/or a plurality of composite particles formed by the method of the first aspect and/or a plurality of composite particles formed from the composite particle precursor formulation of the second aspect.

In a fifth aspect, there is provided an electrochemical cell including: an anode, a cathode, and an electrolyte arranged between the anode and the cathode; wherein at least one of the anode or the cathode comprises a plurality of composite particles of the third aspect and/or a plurality of composite particles formed by the method of the first aspect and/or a plurality of composite particles formed from the composite particle precursor formulation of the second aspect.

The various features and embodiments of the present invention, referred to in individual sections above apply, as appropriate, to other sections, mutatis mutandis. Consequently, features specified in one section may be combined with features specified in other sections as appropriate.

### BRIEF DESCRIPTION OF THE DRAWINGS

FIG. 1 is a graphical representation of zeta potential for silicon nanoparticles activated oligomeric metal coordination complexes: A—at pH 4.5 (unmodified); B—acetate capped at pH 4.5; C—at pH 3.0; D—acetate capped at pH 3.0; and E—Control;

FIG. 2 shows the sizes of different activated nanoparticles: A—at pH 4.5; B—acetate capped at pH 4.5; C—at pH 3.0; D—acetate capped at pH 3.0; and E—Control;

FIG. 3 is a graphical representation of zeta potential for PAA coated and uncoated magnetic nanoparticles activated with oligomeric metal coordination complexes: A—at pH 4.5 (unmodified); B—acetate capped at pH 2.4; C—oxalate capped at pH 3.2; and D—Control;

FIG. 4 shows the sizes of different activated nanoparticles: A—at pH 4.5 (unmodified); B—acetate capped at pH 2.4; C—oxalate capped at pH 3.2; and D—Control;

FIG. 5 shows pictures of spray dried particles before (1) and after bath sonication for 45 mins (2). The particles were formed using oligomeric metal coordination complexes: A—at pH 4.5 (unmodified); B—acetate capped at pH 2.4; C—chromium acetate at pH 4.2. The grid is 10×10 microns;

FIG. 6 shows two SEM images (at different magnifications only) of solids as formed in Example 3, using Precursor Formulation 3 (using unmodified metal complex) after spray drying;

FIG. 7 shows two SEM images (at different magnifications only) of solids as formed in Example 3, Precursor Formulation 3 (per FIG. 6) after slurry preparation and casting onto copper foil;

FIG. 8 shows a series of SEM images of solids as formed in Example 3, Precursor Formulation 3 and casting onto copper foil (per FIG. 7) after further coin cell assembly and cycling;

FIG. 9 shows two SEM images (at different magnifications only) of composite particles as formed in Example 3, Composite Particle Precursor Formulation 4 (a modified metal complex) after spray drying;

FIG. 10 shows two SEM images (at different magnifications only) of composite particles as formed in Example 3, Composite Particle Precursor Formulation 4 (per FIG. 9) after slurry preparation and casting onto copper foil;

FIG. 11 shows a series of SEM images of composite particles formed in Example 3, Composite Particle Precursor Formulation 4 and casting onto copper foil, per FIG. 10, after coin cell assembly and cycling;

FIG. 12 shows a SEM image of solids formed in Example 3, Precursor Formulation 1 (unmodified metal complex) after slurry preparation and casting on copper foil;

FIG. 13 is a SEM image of composite particles formed in Example 3, Composite Particle Precursor Formulation 2 (a modified metal complex) after slurry preparation and casting onto copper foil;

FIG. 14 is a SEM image of composite particles as formed in Example 3, Composite Particle Precursor Formulation 4 (a modified metal complex) after slurry preparation and casting on copper foil;

FIG. 15 is a SEM image of composite particles formed in a similar manner to FIG. 14 (Example 3, Composite Precursor Formulation 4 except that 0.5% polyacrylic acid solution was used instead of a 2% solution) after slurry preparation and casting on copper foil;

FIG. 16 is a SEM image of composite particles formed in Example 3, Composite Particle Precursor Formulation 4 (a modified metal complex). The composite particles were mixed with epoxy resin and after the mould was set, it was grounded and polished to reveal a porous structure. The upper figure is the SEM of particles and the lower figure is a SEM of a cross-section of one composite particle;

FIG. 17 is a SEM image of composite particles formed in Example 4, Preparation of Porous Composite Precursor Formulation 6 (using Porogens);

FIG. 18 are SEM images of composite particles after slurry preparation and casting on copper foil formed by two different methods. The top SEM images show particles formed when modified metal complexes (Solution 7) were added at the beginning of the Precursor Formulation process. The bottom SEM images show particles formed when the modified metal complex was added as the last step prior to spray drying; and

FIG. 19 shows a graph of electrochemical data after 100 cycle of charge and discharge of the fabricated half coin cell at 0.5 C (1 C=4,200 mAh/g). These cells showed a stable cycling performance after 40 cycles with a capacity retention of ˜84% after 100 cycles.

Further aspects of the present invention and further embodiments of the aspects described in the preceding paragraphs will become apparent from the following description, given by way of example and with reference to the accompanying drawings.

### DETAILED DESCRIPTION OF THE EMBODIMENTS

The present invention is predicated, at least in part, on the finding that certain modified oligomeric metal coordination complexes strongly coordinated to active material particles, to form an “activated” particle, are subsequently able to strongly coordinate with polymers in a controlled manner. The result, however, is not simply a polymer-coated particle. Rather, due to control of the coordination reactions with the modified oligomeric metal coordination complexes, these activated particles are able to form cross-linked clusters with the polymer and, in this respect, they can be considered functionally akin to cross-linking agents, such as divinylbenzene.

Without appropriate control, multiple coordination (cross-linking) sites are formed on the activated particle surface and its reactivity with the polymer can lead to an uncontrolled process resulting in polymeric gel-type materials or precipitates of non-uniform composite materials and even the metal complex itself. Forming composite particles, encapsulating bound active particles, having relatively tight inter- and intra-particle uniformity without achieving a high degree of control over the process of formation is extremely challenging. Nonetheless, when such highly uniform interconnected composite particles are formed, any encapsulated particles are strongly bound within the polymeric particle network by dative covalent bonding and the entire composite particle will be robust and highly stable and, so, suitable for use in many challenging environments and commercial applications.

One such application is the production of composite particles (or porous polymeric particles) comprising silicon and/or carbon nanoparticles coordinated with oligomeric metal coordination complexes for use in Li-ion batteries. Without wishing to be bound by theory, the inventors believe that by controlling the kinetics of coordination of the modified oligomeric metal coordination complex-coated active material particles (i.e. the activated particles) to the polymer, it is possible to form stable composite particles of controlled size, nanoparticle density/composition and porosity. The modification of the oligomeric metal coordination complexes and the reaction conditions employed can be used to control the reaction kinetics appropriately. By way of example, when such an approach is used to form composite particles (or porous composite particles) comprising silicon nanoparticles coated with oligomeric metal coordination complexes within a polymeric network backbone, the silicon nanoparticles are not just embedded or physically trapped within the composite particle but rather they are bonded to the polymeric backbone, and to other silicon nanoparticles, to form a physically bonded network which accommodates expansion and contraction driven by lithium ion intercalation and deintercalation, when incorporated into an anode material, and resists cracking or stressing due to swelling of the silicon particle. Therefore, rather than having to handle and deal with the manufacturing challenges of using silicon nanoparticles directly in anode formation, the present approach means the silicon nanoparticles are effectively produced as clusters within larger composite particles which are considerably more suitable for handling and use in electrode fabrication.

In a first aspect, although not necessarily the broadest aspect, the invention provides a method of forming a composite particle including the step of: contacting an active material particle (or at least one active material particle), a modified oligomeric metal coordination complex, and at least one polymer, to thereby form a composite particle.

In one embodiment, the at least one polymer is capable of forming coordinate bonds with the modified oligomeric metal coordination complex.

In another embodiment, the step of contacting comprises:
(i) Contacting the modified oligomeric metal coordination complex and the active material particle to form an activated particle; and
(ii) Contacting the activated particle and the at least one polymer.

In a further embodiment, the step of contacting comprises:
(i) Contacting the active material particle with the polymer; and
(ii) Contacting the product of (i) with the modified oligomeric metal coordination complex.

In one embodiment, the first aspect may provide a method of forming a composite particle including the steps of:
(i) mixing an active material particle, a modified oligomeric metal coordination complex, at least one polymer and a liquid carrier to provide a mixed solution; and
(ii) at least partially removing the liquid carrier from the mixed solution;
   to thereby form a composite particle.

In one embodiment, the step of at least partially removing the liquid carrier from the mixed solution may comprise spray drying, rotary evaporation or evaporation with heating under stirring. In one embodiment, the step of at least partially removing the liquid carrier from the mixed solution may be a step of removing the liquid carrier from the mixed solution. In one embodiment, the step of at least partially removing the liquid carrier from the mixed solution may comprise at least partially removing free liquid carrier. The term “free liquid carrier” refers to liquid carrier that is unbound to a component of the liquid formulation, such as the metal coordination complex, the polymer, or the active material particle.

In one embodiment of the first aspect there is provided a method of forming a composite particle including the steps of:
(i) providing a plurality of activated particles comprising active material particles at least partially coated with a modified oligomeric metal coordination complex; and
(ii) contacting the plurality of activated particles with at least one polymer capable of forming coordinate bonds with the modified oligomeric metal coordination complex,

to thereby form a composite particle.

In the present specification and claims, the word ‘comprising’ and its derivatives including ‘comprises’ and ‘comprise’ include each of the stated integers but does not exclude the inclusion of one or more further integers.

The term “composite particle”, as used herein, is intended to encompass nano- or micron-sized discrete particles which comprise smaller nano-sized or micron-sized active material metallic, intermetallic, metalloid, carbon, or ceramic particles, a majority of which are linked directly to each other or to a polymeric network of the composite particle, by one or more oligomeric metal coordination complexes. When the various components forming the composite particles are mixed initially with a polymer to form uniformly dispersed suspensions, slurries or blends prior to formation of the final composite particle, the mixtures are referred to herein as composite precursor formulations. When these formulations are converted into the final discrete particles, they are referred to herein as composite particles. The shape of the composite particles is not particularly limited but substantially spherical composite particles are preferred.

In embodiments, the composite particles described in any of the aspects herein may have an average particle diameter of between about 0.2 μm to about 100 μm; between about 0.5 μm to about 80 μm; between about 1.0 μm to about 50 μm; between about 3.0 μm to about 40 μm; between about 4.0 μm to about 12 μm; between about 6.0 μm to about 9 μm; or between about 1.0 μm to about 5 μm.

Preferred average particle diameters of the composite particles include those between about 0.5 μm to about 60 μm; between about 0.5 μm to about 50 μm; between about 0.5 μm to about 40 μm; between about 0.5 μm to about 30 μm; between about 0.5 μm to about 20 μm; between about 0.5 μm to about 10 μm; and between about 0.5 μm to about 5 μm.

Particularly preferred average particle diameters of the composite particles include those between about 0.7 μm to about 40 μm; between about 0.7 μm to about 30 μm; between about 0.7 μm to about 20 μm; and between about 0.7 μm to about 10 μm.

In one embodiment, the composite particles have an average particle diameter of less than about 10,000 nm, or less than about 5,000 nm, or less than about 2,000 nm.

The term “active material”, as used herein, is intended to encompass any particulate, preferably nanoparticulate, material which has an active functional role in a process or application within some larger composite material. In one non-limiting example, the active material may be a constituent part of an electrode that is involved in the electrochemical charge and discharge reactions. Therefore, in embodiments, at least one active material will contribute significantly to conductivity when incorporated within a composite particle and further within an electrode material. The active material may, in certain embodiments, also be referred to as an intercalation material or compound, which is a material or compound that can undergo both intercalation and deintercalation of an electrolyte ion to effect charge and discharge cycles. In one non-limiting example, the active material may be a material such as silicon and/or graphite or other carbon particle, useful in the formation of electrodes.

The terms “particle” and “nanoparticle”, as used herein in relation to active materials, refers to nano-sized or micron-sized components which may be of any shape including generally spherical particles, tubes, threads, nanocages, nanocomposites, nanofabrics, nanofibers, nanoflakes, nanoflowers, nanofoams, nanomeshes, box-shaped, nanopillars, nanopin films, nanoplatelets, nanoribbons, nanorings, nanorods, nanosheets, nanoshells, nanotips, quantum dots, quantum heterostructures and sculptured thin films. Whatever the shape or morphology of the active material particle, at least one type of said particle is required to be coordinated with oligomeric metal coordination complexes to form an ‘activated’ particle. In one non-limiting example, the active material particle may be a material such as silicon and/or carbon nanoparticles which may be at least partially coated with a modified oligomeric metal coordination complex to form an activated nanoparticle.

The active material particles may be of an average diameter of less than about 10,000 nm, or less than about 5,000 nm, or less than about 2,000 nm. The activated particles can therefore be considered to be a roughly similar scale.

In preferred embodiments of any of the aspects described herein, the active material particles may be of an average diameter of less than about 1,000 nm and so will be referred to as “active material nanoparticles”. It will therefore be understood that references herein to “active material nanoparticles” and “activated nanoparticles” are considered to be references to “active material particles” and “activated particles” wherein the active material particles are of an average diameter of less than about 1,000 nm. Active material nanoparticles are preferred as they present a much larger surface area for interaction with the modified oligomeric metal coordination complex which provides for optimal reaction rates taking into account the overall reduced reactivity of the modified oligomeric metal coordination complex.

In embodiments, the surface of the active material includes a nitrogen, oxygen, sulfur, hydroxyl, or carboxylic acid species having a lone pair of electrons for forming a dative bond. Preferably, the surface includes an oxygen species. Oxygen species are preferred as generally, the surface of the active material can be easily oxidised to include an oxide layer or may already be considered an oxide. Thus, in a preferred embodiment the active material surface is, or is adaptable to become, an oxide surface.

In an embodiment, the active material (or at least one active material if more than one is present) particles or nanoparticles are selected from the group consisting of metals, intermetallic compounds, metalloids, metal oxides, clays, carbon-based particles or nanoparticles, and ceramics. In certain embodiments, silicon is a preferred metalloid. In embodiments, gold and magnetite nanoparticles are preferred metal and metal oxides. In embodiments, gold, mixed silver/gold, copper, zinc oxide, tin and aluminium nanoparticles are preferred metal and metal oxides.

In one embodiment, the active material is selected from silicon, silicon containing materials (its oxides, composites and alloys), tin, a tin containing material (its oxides, composites and alloys), germanium, germanium containing material (its oxides, composites and alloys), carbon, and graphite. If a composite particle is being formed for use in anode production then the active material is typically selected from silicon, silicon containing materials (its oxides, composites and alloys), tin, a tin containing material (its oxides, composites and alloys), germanium, germanium containing material (its oxides, composites and alloys), carbon, and graphite. Preferably, when the electrode is an anode, the active material comprises silicon and/or carbon. Silicon may be in the form of pure silicon, its various oxides (which may be defined as SiOₓ and including SiO, SiO₂, etc.), its alloys (Si—Al, Si—Sn, Si—Li, etc.), and composites (Si—C, Si-graphene, etc.). It is preferred that the carbon is in the form of graphite and any one or more of its various forms and morphologies, super-P carbon, graphene, carbon nanotubes, carbon nanofibers, carbon microfibers, acetylene carbon black, Ketjenblack (KB); and other carbon-based materials.

In one embodiment, the active material comprises silicon. References herein to ‘silicon’ may include silicon dioxide (SiO₂).

In one embodiment, the active material is selected from those comprising sulphur, LiFePO₄ (LFP), mixed metal oxides which include cobalt, lithium, nickel, iron and/or manganese, phosphorus, aluminum, titanium and carbon. If a composite particle is being formed for use in cathode production then the active material (or at least one active material if more than one is present) may be selected from those comprising sulphur, LiFePO₄ (LFP), mixed metal oxides which include cobalt, lithium, nickel, iron and/or manganese, phosphorus, aluminum, titanium and carbon. It is preferred that the carbon is in the form of one or more carbon particles selected from graphite, super-P carbon, graphene, carbon nanotubes, carbon nanofibers, acetylene carbon black, Ketjenblack (KB); and other carbon-based materials.

In embodiments wherein there is to be a first and a second active material incorporated within a composite particle, it may be preferred that the first active material comprises silicon and the second active material comprises carbon, both as defined above.

It will be appreciated from the disclosure herein that the active material particles (or nanoparticles) for forming the activated particles (or nanoparticles) are not particularly limited and any such material used in the prior art may be appropriate so long as it is capable of binding to a modified oligomeric metal coordination complex. When the composite particles are being formed for use in electrodes or other battery materials then the active material particles (or nanoparticles) may be selected from any of those currently in use for lithium ion secondary batteries, and more particularly those employing a silicon-based anode.

When the active material particles are nanoparticles, the active material nanoparticles encompass a number for an average particle diameter of from about 1 nm to about 1000 nm. Preferably, the number average particle diameter is at least 10 nm. More preferably, the nanoparticles have a number average particle diameter of at least 30 nm. Even more preferably, the nanoparticles have a number average particle diameter of at least 50 nm. Most preferably, the nanoparticles have a number average particle diameter of at least 70 nm. Each of these lower end diameters can be considered to be paired in an average particle diameter range with an upper limit selected from 1000 nm, 900 nm, 800 nm, 700 nm, 600, nm, 500 nm, 400 nm, 300 nm, 200 nm, 150 nm and 100 nm.

In some embodiments, the active material particle may be at least one active material particle. For example, the at least one active material particle may be at least two, three, four or five active material particles; or two, three, four or five active material particles.

In embodiments wherein there is to be a first and a second active material incorporated within a composite particle it will be appreciated that those first and second active material particles may be of different sizes. For example, the first active material particles may be nanoparticles and the second active material particles may be micron-sized, and so on for any additional active materials present.

The modified oligomeric metal coordination complex can coordinate to any electron-donating groups on the surface of the active material particles. Even active material particles purported not to have electron donating groups often have such groups as a consequence of our oxygenated atmosphere. Accordingly, the active material particles include a surface having electron-donating groups, and the metal ions of the modified oligomeric metal coordination complex are bound via a dative bond to these electron-donating groups of the active material particles. Suitable electron-donating surface moieties include oxides.

In the rare instances where there are little or no electron-donating groups on the surface of the active material particles, at least some ligands of the modified oligomeric metal coordination complex can be hydrophobic ligands (R—X), where X coordinates to the metal ion and so where X may be any electron-donating group that is able to form a co-ordination bond with the metal ion. The group “R” may be independently selected from alkyl, heteroalkyl, alkenyl, alkynyl, cycloalkyl, heterocycloalkyl, alkylcycloalkyl, heteroalkylcycloalkyl, aryl, heteroaryl, aralkyl and heteroaralkyl, which groups are optionally substituted. In accordance with this embodiment, “R” is preferred to have more hydrophobic character. Further, the R group may also incorporate moieties selected from a lithium ion conducting polymer, a conjugated diene-containing group, a polyaromatic- or heteroaromatic-containing group, a nitrogen-containing group, an oxygen-containing group, or a sulfur-containing group. Preferably the “R” group is a short polymer such as shorter versions of polymeric binders such as polyvinylidene fluoride (PVDF), poly(styrene butadiene), polyethylene and its copolymers, polypropylene and its co-polymers, and polyvinyl chloride.

In such instances wherein at least some ligands of the modified oligomeric metal coordination complex are hydrophobic ligands (R—X), it will be necessary to select the ratio of the R group to the available coordination potential of the metal complex. This selection will allow both coordination and hydrophobic interactions with the surface of the active material but still provide for remaining coordination potential.

As mentioned, the use of hydrophobic ligands (R—X as defined above) will be relatively uncommon and particularly so when anode materials are being prepared. Therefore, in one embodiment wherein the active material is as described above for either anode or cathode applications, then the oligomeric metal coordination complex does not comprise a substantial number of hydrophobic ligands. That may mean that less than 40%, 30%, 20% or 10% of the possible ligand binding capacity of the modified oligomeric metal coordination complex is taken up by such hydrophobic ligands. In one embodiment there may be substantially no hydrophobic ligands on the modified oligomeric metal coordination complex.

In embodiments, the activated particles will be at least partially coated with the modified oligomeric metal coordination complex. The partial coating may be coordinate bonding between the activated particle surface and at least a number of metal ions, such as a plurality, within the modified oligomeric metal coordination complex. In some embodiments, the activated particle may be substantially encapsulated by one or more modified oligomeric metal coordination complexes.

The proportions of the different components of the mixture during step (ii) (contacting the plurality of activated particles with at least one polymer capable of forming coordinate bonds with the modified oligomeric metal coordination complex) may be of importance in controlling the formation of homogeneous composite particles of desired composition, size and physical characteristics. While the relative concentration of the oligomeric metal coordination complexes to at least one polymer may be controlled, at one extreme, relatively low percentages of active material particles can be activated by the modified oligomeric metal coordination complex and the remainder left unreacted. At the other extreme, substantially all active material particles may be activated by metal complexes. Therefore, in embodiments, the method may include the step of controlling or adjusting the relative concentration of the modified oligomeric metal coordination complex and active material nanoparticle.

In embodiments, the amount of modified oligomeric metal complex is determined by the weight of active material present. As the metal complex is normally added in excess, conditions of activation (concentration, temperature and time), and removal of unreacted oligomeric metal complex (method, washing steps, etc) can significantly affect the level of activation. However, once the degree to which the modified oligomeric metal complex has activated the active material is established, the weight of active material is one key variable.

In embodiments, when the modified oligomeric metal coordination complex is not added in excess, the net charge of the active material particles may be further modified to also contribute to particle aggregation prior to polymer addition. Unmodified oligomeric metal coordination complexes are normally added in excess to maintain charge-charge repulsion of metal complex activated particles. When such unmodified complexes are not used in excess, this can lead to rapid and uncontrolled aggregation. In contrast, the use of modified oligomeric metal coordination complexes allows greater control over particle aggregation which leads to more uniform particle density and distribution. This is especially important when composite particles comprising two or more different particles needs to be formed.

It will also be appreciated that further control over the extent of binding between activated particles and polymer, thereby affecting the properties of the formed composite particle, can be influenced by control of the reaction pH, the temperature, approach to mixing and the relative concentrations of activated particles to polymer and relative concentration of modified oligomeric metal coordination complex coordinated on the active material particles to the polymer. Therefore, in embodiments, the method may further include the step of controlling the reaction pH and/or temperature and/or mixing and/or relative concentrations of active material particle and/or modified oligomeric metal coordination complex and/or polymer, when the three components are exposed to one another.

In embodiments, the amount of polymer (or polymer binder) to a set weight of active material(s) is in the range of 40:1, 20:1, 10:1, 8:1, 4:1, 2:1, 1:1, 1:2, 1:4 and 1:10. Ratios in the range of 10:1, 8:1. 4:1, 2:1 and 1:1 may be preferred. In one embodiment, the amount of polymer binder to a set weight of active material(s) is in the range of from 40:1 to 1:2, or from 20:1 to 1:2, or from 10:1 to 1:1. As a convention, the ratio referred to is the ratio (in mmoles) of coordinating ligands in the polymer binder per gram of activated active material. In molar terms for a known weight of polymer binder, the ligand number will vary significantly between binders such as polyacrylic acid, alginic acid, CMC, etc. Further, the coordination potential of the ligand will also affect the ratio. As an example, the coordination strength of a carboxylic acid group ligand will be stronger than a hydroxyl group ligand. The ratios described above refer to carboxylic based ligands and, when other ligands are used, the ratios can be adjusted according to the relative coordination strength of the ligands. The proportions of the modified metal coordination complex (or modified oligomeric metal coordination complex) to the active material and polymer may change according to the type/reactivity of the modified metal coordination complex (or modified oligomeric metal complex).

In embodiments, where the modified metal coordination complex (or modified oligomeric metal coordination complex) is first added in excess to the active material, the mixture may be filtered to remove the majority of unbonded metal coordination complex. Where the modified metal coordination complex (or modified oligomeric metal coordination complex) is not added in excess, the relative amount by weight of modified metal coordination complex added may be dramatically different between a nanoparticle and a micron particle active material. If other active materials including porous or semi-permeable particles are used, it may also affect the relative proportions of these components to the modified metal coordination complex (or modified oligomeric metal coordination complex). It will also be appreciated that the potential for coordination may also be affected by the manufacturing history such as the degree of oxygenation of a given batch of silicon particle.

In one embodiment (especially where the modified metal coordination complex (or modified oligomeric metal coordination complex) is not added in excess), the active material:modified metal coordination complex ratio may be in the range of 1000:1, 500:1, 300:1, 150:1, 50:1, 25:1, 10:1, 5:1 or 1:1; or in the range of 360:1, 170:1. 85:1, 50:1, 25:1, 10:1 or 5:1. In another embodiment (especially where the modified metal coordination complex (or modified oligomeric metal coordination complex) is not added in excess), the polymer:modified metal coordination complex ratio may be in the range of 1000:1, 500:1, 300:1, 150:1, 50:1, 25:1, 10:1, 5:1 or 1:1; or in the range of 360:1, 170:1. 85:1, 50:1, 25:1, 10:1 or 5:1. As used in this paragraph, the described ratio is the ratio of the actual number of coordinating moieties in the polymer per one metal atom in the modified metal coordination complex (or the modified oligomeric metal coordination complex); or the ratio of the actual number of coordinating moieties in the active material per one metal atom in the modified metal coordination complex (or the modified oligomeric metal coordination complex). In molar terms, for a known weight of polymer, the ligand number will vary significantly between binders such as polyacrylic acid, alginic acid, CMC, etc. The coordination potential of the relevant moiety (or moieties) may also affect the ratio. As an example, the coordination strength of a carboxylic group ligand will be stronger than a hydroxyl group ligand. The ratios described above especially refer to carboxylic based ligands and when other ligands are used, the ratios may be adjusted according to the relative coordination strength of the ligands. In one embodiment, the presence of active materials is ignored for the calculation of ratios.

Similarly, one standard weight for different modified metal complexes (or modified oligomeric metal complexes) may vary with molecular weight of the starting material, the degree of oligomerisation, type of capping, method of synthesis (which may affect the reactivity of the capping groups), etc.

Further, the degree of modification, for example the extent or excess of capping of the modified oligomeric metal coordination complex, and the pH of the reaction can be controlled in tandem to modify the morphology of the composite particles being formed. As shown in the experimental section, adjustment of these parameters, alone or in concert, can have a direct effect on, for example, the size and stability of the particles.

In embodiments, the modified oligomeric metal coordination complex may be defined as a reduced reactivity oligomeric metal coordination complex, especially relative to the same metal ion which is fully hydrated (for example a hexahydrate).

In embodiments, the modified oligomeric metal coordination complex is modified such that its reactivity is reduced as compared with the same oligomeric metal coordination complex which has not been so modified, for example the same metal coordination complex but in a fully hydrated state (for example in the form of a hexahydrate). In one embodiment, the unmodified metal coordination complex has non- or weakly coordination anions as ligands.

In embodiments, the reduced reactivity of the modified oligomeric metal coordination complex may be defined as a reduced level of reactivity as compared with an unmodified metal complex, for example an unmodified oxo-bridged chromium (III) complex. The unmodified metal complex may be a fully hydrated metal complex. The oxo-bridged chromium (III) complex may be a fully hydrated oxo-bridged chromium (III) complex.

In embodiments, the unmodified oxo-bridged chromium (III) complex used for comparison purposes may be that as formed in ‘Solution 1’ of Example 1 in the examples section.

In embodiments, the modified oligomeric metal coordination complex is modified such that its reactivity to, or speed to bond with, the at least one polymer is reduced as compared with the same oligomeric metal coordination complex which has not been so modified.

In embodiments, the polymer used to assess the reduced reactivity by comparison to that with an unmodified oligomeric metal coordination complex is PAA.

In embodiments, the reduced reactivity of the modified oligomeric metal coordination complex may be defined as a reduced level of reactivity with PAA as compared with that of a corresponding unmodified metal complex, especially a corresponding fully hydrated metal complex (such a complex has non- or weakly coordination anions as ligands).

In embodiments, the reduced reactivity of the modified oligomeric metal coordination complex may be defined as a reduced level of reactivity with PAA as compared with that of an oxo-bridged chromium (III) complex. In embodiments, the oxo-bridged chromium (III) complex used for comparison purposes may be that as formed in ‘Solution 1’ of Example 1 in the examples section.

In embodiments of any of the aspects described herein, the at least one modified metal coordination complex is a capped metal coordination complex and/or a metal coordination complex formed at a low pH (for example at a pH below 3.8).

In embodiments, the modified oligomeric metal coordination complex has been modified to display capping groups coordinately bound to the metal of the oligomeric metal coordination complex. The capping groups will alter the reaction kinetics of the now modified oligomeric metal coordination complex with moieties in the at least one polymer as they will be more resistant to being displaced (due to their greater relative coordinating potential) than, for example, simple counterions. The moieties of the at least one polymer will therefore react with more activated particles to form clusters of particles as opposed to reacting with multiple metal complexes on one particle and just coating a particle with the polymer. This slowing of the coordination between activated particle and polymer allows for a more controlled and uniform integration of the components in the composite particle being formed. It will be appreciated that a much higher degree of uniformity, distribution and binding between activated particle and multiple polymers and, indeed, adjacent activated particles can be achieved when this reaction rate is controlled. In the absence of such controlled reactivity, a high or uncontrolled coordination results in the formation of many individual polymer coated particles and individual polymer particles, as opposed to clusters of activated particles interconnected within a composite particle.

In embodiments, the method may further include the step of selecting or controlling the relative extent of the total coordination capacity of the oligomeric metal coordination complex which is taken up by the capping groups. That is, there may be benefits in choosing or modifying the % of the total coordination capacity of the metal ions of the oligomeric metal coordination taken up by capping groups (as measured by that remaining following formation of the oligomeric metal coordination complex itself—as a coordination interaction is reversable, this percentage is the starting percentage taken up by the capping groups). For example, the % of the total coordination capacity taken up by capping groups may be greater than 10%, or 20% or 30% or 40% or 50% any of which values may be combined to form a range with a maximum value of less than 100%, 90%, 80% or 70%. As well, 100% may include addition of capping groups in excess of the available coordination potential of the oligomeric metal complex. In this situation, the degree of excess also changes the reaction kinetics of the now modified oligomeric metal coordination complex with the at least one polymer as there are more capping groups in competition.

The use of active materials in forming electrodes and related materials was discussed in the applicant's earlier International publication nos. WO2016168892 and WO2017165916, which are hereby incorporated by reference in their entirety. In these documents activated materials, such as silicon, were exposed to metal-ligand complexes and binders, including polymeric binders, in the formation of electrode materials. However, the approach describes only slurries suitable for coating current collectors to form an electrode material, which presented a useful advance in performance of this electrode material over those of the prior art, and coating methods for the protection of active materials such as silicon, and improved adhesion to other materials within the electrode. There was no discussion in these publications of the formation of discrete composite particles which could be conveniently stored and safely used for later formation of electrode, and other, materials. Additionally, there was no discussion around controlling the porosity of a matrix adjacent active particles, such as silicon, which is provided for as described herein by the formation of composite particles. More importantly, even if the electrode slurries of these documents had been converted into discrete particles, they would not actually have resulted in the presently claimed composite particles. This is because there was no realisation within these documents of the benefits of controlling the rate of binding between the metal-ligand complex and polymer. The metal-ligand complexes described were highly reactive and so while the electrode materials formed provided very useful conductivity and resistance to swelling, they were not appropriate to form composite particles. The slurries at the dimensions of an electrode per se produced consistent and reproducible outcomes but the uniformity of the slurries when converted to the targeted dimensions of a composite particle (such as about 0.2 μm to about 100 μm) would be inadequate. The unmodified reactivity of the metal-ligand complexes meant that a significant number of the silicon nanoparticles would be entirely encapsulated by a polymer, and not in the form of appropriately activated nanoparticle clusters suitable for forming composite particles, and, importantly, the metal-ligand complexes were so reactive with the polymer that the polymer would outcompete the silicon and the result would be many polymer particles or clusters held together by the metal-ligand complexes which had no embedded or encapsulated silicon at all.

It will be appreciated then that the slurries of the applicant's earlier publications were not homogeneous in terms of forming discrete uniform clusters of interconnected active material nanoparticles within a porous polymeric network. In fact, the inventors have found that conversion of the slurries of International publication no. WO2016168892 into particulate form for easier handling and use resulted in solids that could not form stable composite particles. During electrode coating, or in the early stages of electrode assembly and charge-discharge cycling, these particles rapidly broke up or disintegrated. While the slurries were suitable for formation of electrode materials where the inconsistencies described above may be considered to generally even out across the entire material, they proved to be entirely inappropriate for formation of composite particles which could be successfully incorporated into electrodes and demonstrate efficacy in both electrode performance and long-term stability in resisting damage from lithium intercalation and deintercalation in the charge-discharge cycles. It was only after significant experimentation that the inventors surprisingly found that the reactivity of the metal-ligand complexes, while suitable when unmodified in electrode formation of a bulk material from a slurry, requires modification to form suitable composite particles designed for the same purpose.

Appropriate capping groups will therefore be those which slow down coordination of the modified oligomeric metal coordination complexes with the polymer but do not prevent it. Additionally, the capping groups allow the total charge value of the activated particle (or nanoparticle) to be controlled to thereby encourage a degree of clustering consistent with the formation of composite particles. Without this control, such as in the approach of the applicant's earlier International publications discussed above, the activated silicon will be predominantly in the form of individual particles. The displacement of the capping groups should occur over an appropriate commercial timeframe which can be easily tested by running parallel reactions of oligomeric metal coordination complexes modified with different capping agents and exposed to the same polymer.

In embodiments, useful capping groups may be those that include nitrogen, oxygen, or sulphur as dative bond forming groups. More preferably, the dative bond forming groups of the capping agent are oxygen or nitrogen. Even more preferably, the capping agent is one comprising a dative bond forming group which is an oxygen containing group.

In embodiments, the oxygen containing group of the capping group is selected from the group consisting of sulphates, phosphates, carboxylates, sulphonic acids and phosphonic acids.

In embodiments, the capping group may be selected from the group consisting of formate, acetate, propionate, oxalate, malonate, succinate, maleate, sulphate, phosphate, and hydroxyacetate. In embodiments, the capping group may be selected from the group consisting of formate, acetate, propionate, oxalate, malonate, succinate, maleate, citrate, sulphate, phosphate, an amino acid, naphthalene acetate, and hydroxyacetate.

In embodiments, the capping group is a monodentate, bidentate or multidentate capping agent. In embodiments, the capping group is a monodentate or bidentate capping agent.

In embodiments, the capping group may have a lower molecular mass and/or lower coordination strength for the oligomeric metal coordination complex and/or lower electron density and/or fewer number of ligand binding sites than the at least one polymer which will displace it.

In embodiments, the capping group has a molecular mass of less than 1000 Daltons, or less than 500 Daltons, or less than 400 Daltons, or less than 300 Daltons. Any of these values may be combined with a lower value of 10, 30 or 50 Daltons to form a range of molecular mass values for the capping agent such as 10 to 1000, 10 to 500, 10 to 400 or 10 to 300 Daltons.

In embodiments, the capping group is not simply a counterion of the oligomeric metal coordination complex or a group donated by a base. For example, in forming oligomeric metal coordination complexes it is common to expose the metal complex to a base, such as ethylene diamine, which simply encourage formation of the desired complexes. While the amine nitrogen may be, to a small degree, incorporated into the formed oligomeric metal coordination complex it does not have a significant enough effect on the subsequent reactivity of the oligomeric metal coordination complex to be considered a capping group. Therefore, in one embodiment, the capping group is not one donated by a base including ethylene diamine.

In embodiments, the capping group is a coordinating capping group. That is, the capping group forms at least one coordinate bond with the oligomeric metal coordination complex.

In one embodiment, the ligand (or capping group) of the modified metal coordination complex and the polymer both comprise a functional group with the same heteroatom (for example, oxygen, sulfur or nitrogen). In one embodiment, ligand (or capping group) of the modified metal coordination complex and the polymer both comprise the same functional group. The polymer may comprise a greater number of functional groups than the ligand (or capping group). Said functional groups may be, for example, a carboxylic acid (or carboxylate), an alcohol, a sulphate, a thiol, a phosphate, or an amide. For example, in one embodiment, the functional group may be a carboxylic acid (or carboxylate). In this embodiment, the capping group may be, for example, an acetate or an oxalate, whereas the polymer comprises a carboxylic acid (or carboxylate), such as carboxymethylcellulose, an alginate or polyacrylic acid. In this embodiment, the capping groups would be expected to exchange with the polymer, as once one carboxylic acid of the polymer has exchanged with a capping group, the likelihood that a nearby carboxylic acid moiety on the polymer would exchange for another capping group would be enhanced.

It will be appreciated that either pre-capped oligomeric metal coordination complexes, i.e. already modified oligomeric metal coordination complexes, can be coordinated to the active material particle to form the activated particle or the capping agent can be added after the oligomeric metal coordination complex has been exposed to the active material particle. Either way, the activated particle, preferably activated nanoparticle, will be formed prior to exposure to the at least one polymer.

Therefore, in embodiments, step (i) of the method of the first aspect (providing a plurality of activated particles comprising active material particles at least partially coated with a modified oligomeric metal coordination complex) must be complete before step (ii) (contacting the plurality of activated particles with at least one polymer capable of forming coordinate bonds with the modified oligomeric metal coordination complex) is carried out. That is, the modified oligomeric metal coordination complex must be coordinately bonded to the active material particles prior to exposure to the at least one polymer.

In embodiments, the modified oligomeric metal coordination complex has been modified to form an oligomeric complex at a pH below 3.8. The inventors have surprisingly found that there is a complex relationship between the size of the formed oligomeric complex, the type of capping group and the excess used, and pH of the oligomeric metal coordination complex solution results in complexes that demonstrate a modified reactivity to the subsequently introduced polymer. While not wishing to be bound by theory, at any pH, the competition for coordination to metal complexes between the various components that form the composite particle changes. At higher pH such as above pH 3.8, the strength of binding of metal complexes to silicon and/or carbon particles (or nanoparticles) progressively grow stronger, and as well, its ability to strongly react with any other ligand such as a polymer also becomes stronger. Higher pH conditions of the metal complex as described in the prior art enhances the coating of particles (or nanoparticles) by any available polymer. At lower pH such as below pH 3.8, the reactivity of the metal complex activated particle (or nanoparticle) decreases and whether augmented by capping groups of certain binding strength and excess, and whether buffered by the capping group to help stabilise some target pH, allows fine control that allows the formation of composite particles as described.

In embodiments, the modified oligomeric metal coordination complex has been modified by formation at a pH below 3.7, or below 3.5, or below 3.5 or below 3.4 or below 3.3 or below 3.2 or below 3.1 or at or below 3.0. The pH at formation will, in combination with all instances of the above cited upper limits, be greater than 1.0.

This pH may be the final pH when the metal coordination complex is considered to have formed. This is because many metal salts, such as chromium salts, are highly acidic and release hydrogen ions as the complexes form. The pH of such a solution can therefore become more acidic over time as the complexes form and it is the final pH which is key to the nature of the metal coordination complex formed, and so, its degree of modification.

Therefore, in embodiments, the method may further comprise the step of forming a modified oligomeric metal coordination complex. The forming may be a modification of an existing oligomeric metal coordination complex or it may be concurrent formation of the oligomeric metal coordination complex and modification of same as it forms.

The step of forming the modified oligomeric metal coordination complex may include contacting the oligomeric metal coordination complex with a solution comprising a capping group. Alternatively, the step of forming the modified oligomeric metal coordination complex may include exposing the corresponding monomeric metal coordination complex to a base to thereby form the modified oligomeric metal coordination complex at a pH below 3.8. Alternatively, the step of forming the modified oligomeric metal coordination complex may be after interaction of the unmodified metal complex with the active material. Alternatively, the step of forming modified oligomeric complex may include reaction of the corresponding monomeric metal coordination complex with capping groups and a base in organic solvents with elevated temperature.

The method may further include the step of adjusting the pH of the liquid formulation, comprising the modified metal coordination complex, to be between pH 1.5 to pH 3.8 and/or controlling the temperature of the liquid formulation to be between 15 to 30° C.

In embodiments, the step of adjusting the pH may include adjusting the pH of the solution in which the metal coordination complexes are forming to ensure the desired degree of modification. This may comprise allowing the pH to become more acidic due to the release of hydrogen ions by the metal salts employed or it may comprise the addition of a base, such as ethylene diamine or a metal hydroxide, to mop up some of the released hydrogen ions to prevent the solution becoming too acidic. If a base is added then the amount will be such that the solution is still acidic, as defined above.

In embodiments, the modified metal coordination complex can be formed via the direct reduction of chromium (VI) oxide in the presence of suitable capping groups such as acetic acid. Once the complex is synthesized, the pH can be adjusted as required.

In embodiments, the metal ion of the oligomeric metal coordination complex, modified or otherwise, is selected from the group consisting of chromium, ruthenium, iron, cobalt, titanium, aluminium, zirconium, and combinations thereof. In embodiments, the metal ion of the metal coordination complex is selected from the group consisting of chromium, ruthenium, titanium, iron, cobalt, aluminium, zirconium, rhodium and combinations thereof.

In embodiments, the metal ion is chromium.

The metal ion of the oligomeric metal coordination complex may be present in any applicable oxidation state. For example, the metal ion may have an oxidation state selected from the group consisting of I, II, III, IV, V, or VI, as appropriate and obtainable under standard conditions for each individual metal. The person of skill in the art would be aware of which oxidation states are appropriate for each available metal.

In an embodiment in which the metal ion is a chromium ion, it is preferred that the chromium has an oxidation state of III.

The metal ion may be associated with any suitable counter-ions such as are well-known in metal-ligand coordination chemistry.

In certain embodiments, mixtures of different metal ions may be used, for example, to form a plurality of different oligomeric metal coordination complexes. In such cases, it is preferred that at least one metal ion is chromium.

Metals are known to form a range of oligomeric metal coordination complexes. Preferred ligands for forming the oligomeric metal coordination complex are those that include nitrogen, oxygen, or sulfur as dative bond forming groups. More preferably, the dative bond forming groups are oxygen or nitrogen. Even more preferably, the dative bond forming group is an oxygen-containing group which assist in olation to form the oligomeric complexes. In embodiments, the oxygen-containing group is selected from the group consisting of oxides, hydroxides, water, sulphates, phosphates, or carboxylates.

In embodiments, the oligomeric metal-coordination complex is a chromium (III) oligomeric metal-coordination complex. In embodiments, the oligomeric metal coordination complex is an oxo-bridged chromium (III) oligomeric coordination complex. This complex may optionally be further oligomerised with one or more bridging couplings such as carboxylic acids, sulphates, phosphates and other multidentate ligands.

Exemplary oxo-bridged chromium structures are provided below, albeit without indication of any appropriate modification of reactivity towards the at least one polymer:

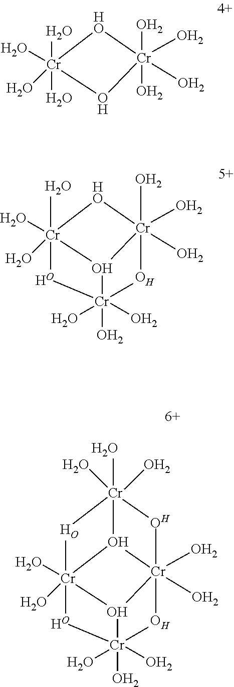

On application to the active material particles (or nanoparticles), at least one of the water or hydroxyl groups (or whatever ligands may be present) on each of the oligomeric metal coordination complexes is replaced by a dative bond with the surface of the active material. This is illustrated below wherein “X” represents the dative bond to the surface of the active material particle (or nanoparticle).

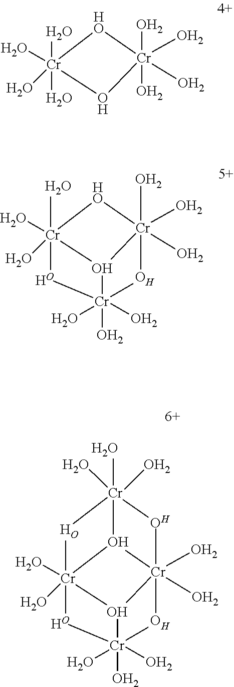

It will also be appreciated that multiple water or hydroxyl or other ligands present on the oligomeric metal coordination complex may be replaced by a dative bond with the surface of the active material particles, for example at least one chromium ion within the oligomeric metal coordination complex may form a dative bond with the surface of the active material particles.

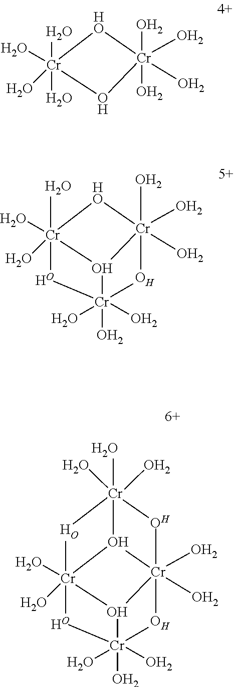

In addition, and given the above discussion regarding the bonding of the activated particles to the polymeric network of the composite particle being formed, it will be appreciated that the water and/or hydroxyl or other ligand groups present may be replaced by a dative bond with an additional component of the formulation, such as a further active material particle, an additional polymer component or binder and the like.

It will also be appreciated that, in embodiments, the modified oligomeric metal coordination complex may include various capping groups having on/off rates which are appreciably slower than pre-existing water and other ligand groups, and hence will affect coordination with an additional component of the formulation, such as a further active material particle, an additional polymer component or binder and the like.

In one embodiment, the metal forming the oligomeric metal coordination complex is not the same as that forming the active material particle. For example, if a chromium oligomeric metal coordination complex is employed then the active material particle is not chromium metal.

In preferred embodiments, the oligomeric metal coordination complex is not incorporated with the active material particles by a melt process. That is, the metal of the oligomeric metal coordination complex is not melted together with the active material particles as this would not result in formation of the required activated particles. It is preferred that the oligomeric metal coordination complex is incorporated into the active material in the liquid phase i.e. in the presence of a suitable liquid carrier or solvent which forms the liquid phase.

The oligomeric metal coordination complex will be discussed below, in terms of available variations in the synthetic approach and the potential for differences thereby achieved in the final product.

The oligomeric metal coordination complexes can be formed by providing conditions for forming electron donating groups for bridging or otherwise linking or bonding two or more metal ions. When not already commercially available, this can be done by providing a pH above pH 1, and preferably between about 1 to 5, or about 2 to 5 to the solution when forming the complexes. Clearly, the chosen pH will depend on the approach by which modification of the oligomeric metal coordination complex is to be achieved. That is, while pHs above 3.8 may be appropriate for forming the oligomeric metal coordination complex when they are to be modified by use of capping groups, a pH below 3.8 is highly desirable for the oligomeric metal coordination complexes formed in aqueous solutions. In non-aqueous solutions, pH cannot be used as an appropriate measure and so metal-coordination complexes to be formed are determined by the amount of base/acid in the organic reaction solvent.

Various chromium salts such as chromium chloride, chromium nitrate, chromium sulphate, chromium acetate, chromium perchlorates, may be used to form a chromium-based oligomeric metal coordination complex. Unless pre-existing in some oligomeric form and used ‘as is’, these salts are mixed with an alkaline solution, such as sodium hydroxide, potassium hydroxide, lithium hydroxide, sodium bicarbonate, sodium sulphite and ammonium hydroxide to form different metal-coordination complexes. Organic reagents that can act as bases such as ethylene diamine, bis(3-aminopropyl)diethylamine, pyridine, imidazoles, can also be used. The size and structure of the oligomeric metal coordination complex can vary with pH, temperature, choice of solvent and other conditions.

In one particular embodiment, when the oligomeric metal coordination complex is a chromium metal-ligand complex then the active material particle (or nanoparticle) does not include aluminium or iron as an additional material.

In embodiments, the contacting of step (ii) (contacting the plurality of activated particles with at least one polymer capable of forming coordinate bonds with the modified oligomeric metal coordination complex) between the plurality of activated particles with at least one polymer capable of forming coordinate bonds with the modified oligomeric metal coordination complex, occurs within a liquid carrier.

The liquid carrier may be an aqueous or organic solvent, or mixture thereof, or the liquid carrier may be a liquid additional active material. In embodiments, the liquid carrier has at least some aqueous component. The liquid carrier may be an aqueous solution. The liquid carrier may be water or an alcohol. The alcohol may be methanol, ethanol, propanol, isopropanol or butanol. In one embodiment, the liquid carrier is water or isopropanol. In one embodiment, the liquid carrier is water.

Preferably, the liquid carrier is an aqueous carrier.

In one embodiment, the composite particle comprises dative bonds between the metal of the metal coordination complex and both the active material and the polymer.

In embodiments, the method may include the step of (or as step (iii)): allowing the modified oligomeric metal coordination complex to become coordinately bonded to the active material particles and the at least one polymer in a liquid carrier, and forming a composite particle from said liquid carrier comprising those bonded components.

In embodiments, the composite particle may be formed by any method that allows for the removal of the liquid carrier or solvent comprising said bonded components. Methods may include spray drying or slow evaporation with heating under stirring or rotary evaporation to concentrate the stabilised composite particles. Such particles could be subsequently filtered, and tray dried in an oven. Suitable evaporation methods may include open-dish evaporation, reduced-pressure evaporation, rotary evaporation, flash evaporation, spray drying, lyophilization, flash evaporation, and the like. Alternatively, the precursor formulation may be pH adjusted and rapidly filtered, or oven dried and then milled to form composite particles. Common equipment for such approaches includes the use of fluid bed dryers, atmospheric or vacuum pan dryers, drum dryers, lyophilisation, flash evaporation equipment and the like.

As described, the at least one polymer may be any natural or synthetic polymer capable of forming coordinate bonds with the modified oligomeric metal coordination complex. The forming of coordinate bonds will be dative bonding between appropriate electron-donating groups of the polymer and metal ions of the modified oligomeric metal coordination complex having available coordination capacity, whether freely available or made available by the displacement of a current ligand by the polymer (such as a capping group displacement). It will be appreciated that the end use of the composite particles may dictate that there may be first, second and even further polymers that are exposed to the modified oligomeric metal coordination complex. In such situations any polymer combinations may be appropriate so long as they are each sufficiently reactive with the modified oligomeric metal coordination complex to form coordinate bonds with the activated particles (or nanoparticles). This will generally always be the case so long as the polymer has sufficient electron-donating groups.

In embodiments, the at least one polymer may be any one or more polymers which possess sufficient molecular mass or electron-donating groups to bond with the modified oligomeric metal coordination complex whether in the absence or presence of capping groups as previously defined. It is an advantage that the oligomeric metal coordination complexes can be bonded to a wide variety of polymers.

The at least one polymer(s) may be hydrophilic or partially hydrophobic.

Representative polymers that are partially hydrophobic may be selected from the group consisting of poly(ester amide), polycaprolactone (PCL), poly(L-lactide), poly(D,L-lactide), poly(lactides), polylactic acid (PLA), poly(lactide-co-glycolide), poly(glycolide), polyhydroxyalkanoate, poly(3-hydroxybutyrate), poly(4-hydroxybutyrate), poly(3-hydroxyvalerate), poly(3-hydroxybutyrate-co-3-hydroxyvalerate), poly(3-hydroxyhexanoate), poly(4-hydroxyhexanoate), mid-chain polyhydroxyalkanoate, poly (ortho ester), polyphosphazenes, poly (phosphoester), poly(tyrosine derived carbonates), poly(methyl methacrylate), poly(methacrylates), poly(vinyl acetate), poly(ethylene-co-vinyl acetate), poly(ethylene-co-vinyl alcohol), poly(2-hydroxyethyl methacrylate).

Representative hydrophilic polymers may be selected from the group consisting of polymers and co-polymers of hydroxyethyl methacrylate (HEMA), PEG acrylate (PEGA), PEG methacrylate, 2-methacryloyloxyethylphosphorylcholine (MPC) and n-vinyl pyrrolidone (VP), Polyvinyl pyrrolidone (PVP), Polyvinyl alcohol (PVA), carboxylic acid bearing monomers such as methacrylic acid (MA), acrylic acid (AA), polyacrylic acid (PAA), hydroxyl bearing monomers such as HEMA, hydroxypropyl methacrylate (H PMA), hydroxypropylmethacrylam ide, alkoxymethacrylate, alkoxyacrylate, and 3-trimethylsilylpropyl methacrylate (TMSPMA), hydroxy functional poly(vinyl pyrrolidone), polyalkylene oxide, cellulose, carboxymethyl cellulose, maleic anhydride copolymers, nitrocellulose, dextran, dextrin, sodium hyaluronate, hyaluronic acid, elastin and chitosan and cross-linked polymers comprising any two or more of these polymers.

In certain embodiments, the at least one polymer forming the basis of the network structure of the composite particle may be or include polyacrylic acid, carboxymethyl cellulose, maleic anhydride copolymers or their combinations and including variations having different molecular weight ranges, branching structures, concentrations, formulation pH and the like.

In embodiments wherein the composite particle is for battery applications then either the at least one polymer may be a binder, or an additional polymeric binder is included. Preferred binder polymers are those comprising oxygen species selected from acrylate, carboxyl, hydroxyl, and carbonyl moieties. However, other polymers without these groups may also be useful depending on the specific criteria, for example suitable polymers may include styrene butadiene rubber and derivatives thereof. Particularly preferred binders are selected from polyvinylpyrrolidone, carboxymethyl cellulose (CMC), polyacrylic acid (PAA), poly(methacrylic acid), maleic anhydride copolymers including poly(ethylene and maleic anhydride) copolymers, polyvinyl alcohol, carboxymethyl chitosan, natural polysaccharide, Xanthan gum, Guar gum, Arabic gum, alginate, and polyimide. Most preferably, the binder is PAA and/or alginate and/or CMC.

In embodiments, the method may further comprise the step of contacting the activated particles, preferably activated nanoparticles, and the at least one polymer, with a liquid and/or solid porogen. Adding significant porosity to the composite particle provides distinct advantages in operation. For example, for applications in anode materials, the use of a porous composite particle comprising uniformly dispersed and interconnected activated particles within a polymeric network efficiently accommodates the expansion and contraction cycle of the material based on charge-discharge. The porous nature of the composite particle significantly contributes to this along with the coordinate bonding between activated particles and polymer backbone which also resists undue expansion and assists in returning the composite particle to its resting state following deintercalation.

Suitable porogens are well-known in the art and may include both water soluble and non-water soluble porogens depending on the composite particle being formed. Water soluble porogens include water as well as water miscible solvents such as alcohols, glycols and diols. Such alcohols as may be appropriate include methanol, ethanol, and isopropanol. Other water soluble porogens can include polymers such as polyethers, different inorganic salts such as sodium chloride and sodium hydrogen carbonate. Water soluble porogens may include reagents used in the formation of composite particles but not remaining as part of the composite particle. Such reagents include unreacted polymer, capping groups, counter-ions of the oligomeric metal complex, etc. Organic solvent-based porogens can include solvents such as toluene, hexane, or cyclohexanone; and small polymers such as polystyrene, polypropylene, polyvinylchloride, nylon and polyurethanes.

In such embodiments, wherein a liquid and/or solid porogen is present, the method may further comprise the step of actively removing the liquid carrier and/or porogen.

In one embodiment, the method may further include the step of agitating the combined mixture of activated particles and at least one polymer alone or combined with one or more of: changing the solvent or solvent ratio; changing pH conditions; and means to remove undesired liquid and/or solid porogen.

The agitating may be shaking, mechanical mixing, rotating, stirring, centrifuging and the like.

In one embodiment, the method of the first aspect of the present invention is performed at a temperature of below 400° C., preferably below 200° C., or below 180° C., or below 160° C. In one embodiment, the method of the first aspect is performed at a temperature of below 150° C., or below 140° C., or below 130° C., or below 120° C., or below 110° C. or below 100° C. In one embodiment, the method of the first aspect of the present invention is performed at a temperature of at least 0° C., especially at least 5° C., or at least 10° C., or at least 15° C. or at least 20° C. In one embodiment, the method of the first aspect is performed at room temperature or greater. In one embodiment, the method of the first aspect is performed at a temperature of from 0° C. to 200° C., especially from 5° C. to 180° C., or from 10° C. to 160° C. It is believed that performing the method at these temperatures advantageously allows the formation of dative bonds between the metal ion of the modified metal coordination complex and other components of the formulation, such as the active material particles and the at least one polymer. It is believed that at higher temperatures oxides and other complexes of the metal ion may form.

In one embodiment, the method of the first aspect of the present invention is performed at a pressure of from 0.5 atm to 5 atm, or from 0.5 atm to 3 atm, or from 0.5 atm to 2 atm, or about 1 atm.

In a second aspect, there is provided a composite particle precursor formulation comprising: an active material particle, an oligomeric metal coordination complex, at least one polymer and a liquid carrier.

In one embodiment, of the second aspect, the liquid carrier comprises at least one capping group. For example, the liquid carrier may comprise acetate ions. Such acetate ions may be derived from a modified metal coordination complex.

In one embodiment of the second aspect, there is provided a composite particle precursor formulation comprising:
(i) a plurality of activated particles comprising active material particles at least partially coated with a modified oligomeric metal coordination complex;
(ii) at least one polymer capable of forming coordinate bonds with the modified oligomeric metal coordination complex; and
(iii) a liquid carrier in which the plurality of activated particles and at least one polymer are located.

Features of the second aspect of the invention may be as described for the first aspect.

In one embodiment, the liquid carrier is an aqueous or organic solvent-based liquid carrier. The nature of the liquid carrier is not particularly limiting on the scope of the present invention as a wide array of liquid solvents will be appropriate for different active materials. In certain embodiments, liquid (at room temperature) ketones, alcohols, aldehydes, halogenated solvents and ethers may be appropriate. In one preferred embodiment, an aqueous, alcohol or aqueous/alcohol liquid carrier is preferred. Such alcohols as may be appropriate include methanol, ethanol, and isopropanol.

In embodiments, the composite particle precursor formulation may further comprise a liquid and/or solid porogen as defined previously.

The composite particle precursor formulation may comprise one or more additional active materials, as is required to form the composite particle, and each additional active material thereof may be selected from the same groups and materials described previously. For example, the composite precursor formulation may further comprise a second active material, third active material, a fourth active material, a fifth active material and so on. Each of these will, when bound to one or more modified oligomeric metal coordination complexes, form a second, third, fourth, fifth and so on, activated particle. At least one or more will be appropriate to bind with at least one polymer within the formulation.

In terms of stabilising the composite particles being formed, in embodiments wherein the particles are for life science applications it may be appropriate to have drying temperatures of room temperature (such as 21° C. at standard pressure) to 60° C. as the particles often do not have to be entirely dry for such applications. For use in battery applications it is more important to dry off the solvent and so temperatures of 100° C. to 200° C. in a vacuum oven may be appropriate.

Spray drying may occur at temperatures from 170° C. to 230° C. with around 210° C. being typical. Calcination is well known in the art and calcination temperatures may be between around 600° C. to about 1000° C.

In a third aspect, there is provided a composite particle comprising a plurality of active material particles, a polymeric network and a plurality of oligomeric metal coordination complexes coordinately bonded to the active material particles and the polymeric network, wherein the majority of at least one active material particle is linked to the polymeric network by one or more of the plurality of oligomeric metal coordination complexes.

As used herein, the term “majority” refers to at least 50%, 60%, 70%, 80%, 90% or 95% of at least one active material particle type being linked through at least one coordination bond to at least one polymer of the composite particle. If more than one active material particle type is present in the composite particle then a majority (as defined above) of at least one of those active material particles will be linked through at least one coordination bond to at least one polymer of the composite particle. It may be that the additional active material particles are likewise linked or they may be simply physically embedded within the matrix but not so linked or bonded to the at least one polymer.

The active material particles, polymeric network and oligomeric metal coordination complex may be as previously described for the first and second aspects. It will be appreciated that the polymeric network of the third aspect results from bonding of the activated particles with the at least one polymer, as defined for the first and second aspects.

It will be appreciated that, once the composite particle is formed, it may no longer be appropriate to refer to the oligomeric metal coordination complex as ‘modified’ and so the oligomeric metal coordination complex is not referred to in this way for the third aspect. That is, the coordination of the at least one polymer to the modified oligomeric metal coordination complex may, at least partially, remove the modified nature of the oligomeric metal coordination complex. This is particularly so if the modification is the presence of capping groups on the oligomeric metal coordination complex as coordination of the polymer will, as previously discussed, cause the capping groups to be dissociated from the oligomeric metal coordination complex. It will therefore be understood that the use of the term “oligomeric metal coordination complex” in relation to the third aspects is reference to a complex resulting from the modified oligomeric metal coordination complex of the first and second aspects but, at least, having a reduced or diminished level of modification when compared with the modified oligomeric metal coordination complex prior to exposure to the at least one polymer.

As defined for the first and second aspects, the composite particle of the third aspect may have second, third fourth, fifth etc. activated particles, and so active material particles, incorporated therein. It may also comprise additional materials which are added to affect the physical properties of the composite particle. For example, additives may be present to allow rapid isolation via use of magnetite nanoparticles or different coloured nanoparticles can be included as labels for the formed composite particles.

Preferred active materials have been described for battery applications, in particular, but, in another non-limiting embodiment, wherein a composite particle is to form part of an immunoassay then at least one active material particle may be selected from one or more of magnetite or other magnetic materials and/or Quantum Dots, carbon and known colorimetric, fluorescence or chemiluminescent nanoparticles.

In embodiments, the second active material particle and any additional active material particles (or nanoparticles) each have a majority of their total number of particles coordinately bonded to other particles and/or to the polymeric network via the oligomeric metal coordination complexes. In embodiments, it may be preferable that any active material particle types present in the composite particle are, at least in the majority, coordinately bonded to the oligomeric metal coordination complexes. In embodiments, it may be that only one or more than one but not all active material particle types present in the composite particle are, at least in the majority, coordinately bonded to the oligomeric metal coordination complexes while remaining active material particle types are coordinately bonded to some smaller extent or may simply be embedded within the composite particle formed.

In preferred embodiments, the active material particles may be silicon and/or graphite and/or other carbon-based particles (or nanoparticles).

The composite particle of the third aspect may be uniform or homogeneous with respect to the dispersal of the activated particles within the polymeric network. The term homogeneous is generally intended to describe well dispersed and well distributed activated particles forming the composite particles, as well to describe uniform and tight size distribution of the composite particles.

In one embodiment, the composite particle of the third aspect is that formed by the method of the first aspect or formed from the composite particle precursor formulation of the second aspect.

In embodiments, the dry composite particles described in any of the aspects herein may have an average porosity between about 20% to about 90%; between about 30% to about 90%; between about 40% to about 80% or between about 50% to about 80%.

In one embodiment, the dry composite particle is not substantially porous.

In embodiments, the composite particles described in any of the aspects herein may have the capacity to expand to about 30%, or to about 60% or to about 100% or to about 200% of their normal size during cycling.

In embodiments, the composite particles described in any of the aspects herein may change porosity and/or swelling capacity depending on the characteristics of the polymeric network and the environment that the composite particle is used in, such as the solvent it is exposed to.

In a fourth aspect, there is provided a composite material comprising a plurality of composite particles of the third aspect and/or a plurality of composite particles formed by the method of the first aspect and/or a plurality of composite particles formed from the composite particle precursor formulation of the second aspect.

The composite material may be selected from a charge collector substrate, an electrode material, and a separator material for a battery application.

In one preferred embodiment, the composite material of the fourth aspect is an electrode material.

The electrode material may be appropriate to form either an anode or a cathode.

As described previously, when composite particles comprising, for example, silicon and/or carbon particles (or nanoparticles) are formed into an electrode material and coated onto a charge collector electrode substrate to form an electrode, despite the strain imposed on the system as a result of cyclic intercalation of electrolyte, such as lithium, the oligomeric metal coordination complex and the porosity of the particle act to mitigate the stresses and strains associated with the expansion and contraction of the active material particles (or nanoparticles). This assists in minimising or preventing deterioration and breakup of the contact between the materials. This unexpected effect of utilising modified oligomeric metal complexes can provide for a long cycle life for such formed electrode materials and provide for higher energy densities and/or faster charge and/or discharge cycles.

It will be appreciated that the composite particles described herein when incorporated within an electrode, may provide certain one or more advantages in operation such as serving to: (i) improve or maintain the stability of the active material; (ii) improve the power performance (rate performance) of the active material particle; (iii) decrease the solubility of certain electrode materials; (iv) increase the cycle life of batteries; (v) improve the safety and ease of handling the active material particles (or nanoparticles) during manufacture and (vi) reduce overall battery waste.

In a fifth aspect, there is provided an electrochemical cell including: an anode, a cathode, and an electrolyte arranged between the anode and the cathode; wherein at least one of the anode or the cathode comprises a plurality of composite particles of the third aspect and/or a plurality of composite particles formed by the method of the first aspect and/or a plurality of composite particles formed from the composite particle precursor formulation of the second aspect.

As a result of incorporation of said composite particles, the electrode may exhibit improved performance as compared with an electrode which does not comprise said composite particles. In certain embodiments, the improved performance is at least one selected from the group consisting of: higher 1^{st} cycle discharge capacity, higher 1^{st} cycle efficiency, higher capacity after 50 to 1000 deep charge/discharge cycles at 100% depth of charge. Preferably, the improved performance is higher capacity after 1000 deep charge/discharge cycles.

In one embodiment the capacity in a full cell after 50 to 1000 deep charge/discharge cycles at 100% percentage depth of discharge of an electrode comprising the composite particles of the present invention is at least 5% greater, or at least 10% greater, or at least 20% greater, or at least 30% greater, or at least 40%, or at least 50% greater, or at least 60% or at least 70% greater than an electrode of the same general composition not comprising such composites particles.

In another embodiment, the improved performance is higher capacity after 200 deep charge/discharge cycles in a full cell; even more preferably, the improved performance is higher capacity after 500 deep charge/discharge cycles in a full cell; most preferably the improved performance is higher capacity after 1000 deep charge/discharge cycles in a full cell.

In one embodiment the capacity 1^{st} cycle efficiency at 100% percentage depth of discharge of an electrode comprising the composite particles of the present invention is at least 1% greater, or at least 3% greater, or at least 10% greater, or at least 20% greater than an electrode of the same general composition not comprising such composites particles. Preferably, the improved 1^{st} cycle efficiency is at least greater than 70%, or at least greater than 80% or at least greater than 85%; more preferably the 1^{st} cycle efficiency is in between 85%-90%; most preferably the first cycle efficiency is between about 90% to about 94%.

In one embodiment the first cycle specific discharge capacity in mAh/g at 100% percentage depth of discharge of an electrode containing the composite particles of the present invention is at least 1.1× (400 mAh/g), or at least 1.3× (450 mAh/g), or at least 1.4× (500 mAh/g), or at least 1.7× (600 mAh/g), or at least 2.0× (700 mAh/g), or at least 2.6× (900 mAh/g), or at least 3.4× (1200 mAh/g), or at least 4.3× (1500 mAh/g), or at least 5.1× (1800 mAh/g), or at least 5.7× (2000 mAh/g) greater, or at least 7.1× (2500 mAh/g), or at least 8.6× (3000 mAh/g) than a state-of-the-art graphite only containing anode of 350 mAh/g. Preferably, the first cycle specific discharge capacity in mAh/g is at least greater than 500 mAhg, or least greater than 600 mAh/g; or least greater than 800 mAh/g, or least greater than 1000 mAh/g, or least greater than 1500 mAh/g; or least greater than 2000 mAh/g, or least greater than 2500 mAh/g, or least greater than 2950 mAh/g more preferably the first cycle specific discharge capacity in mAh/g is in between 1000 and 2500 mAh/g; or between 700 and 800 mAh/g; or the first cycle specific discharge capacity is between about 1000 to about 1500 mAh/g or between about 1000 to about 1400 mAh/g.

It will be understood that the invention disclosed and defined in this specification extends to all alternative combinations of two or more of the individual features mentioned or evident from the text or drawings. These different combinations constitute various alternative aspects of the invention.

### EXAMPLES

### Example 1: Preparation of Oligomeric Metal Coordination Complex Solutions

Different solutions of oligomeric metal coordination complexes were formed as described below. Depending on the metal ion, salt, the base, the final pH, capping groups, other ligands used and method of its synthesis, the oligomeric metal coordination complex solutions exhibit different binding properties which can be tailored to the particle (or nanoparticle) being activated with the oligomeric metal coordination complex. As a result, the activated particle (or nanoparticle) thereby formed can have different clustering properties and reactivities when coordinating with a polymer.

### Unmodified Oligomeric Metal Coordination Complex

### Solution 1

In this example, chromium perchlorate hexahydrate (45.9 g) was dissolved into 480 mL of purified water and mixed thoroughly until all solids had dissolved. Similarly, 8 mL of ethylene diamine solution was added to 490 mL of purified water. The solutions were then combined by the dropwise addition of EDA solution into the chromium salt solution and the resultant mixture stirred overnight at room temperature, and then left to equilibrate to a pH of approximately 4.5. This metal coordination complex rapidly binds to different materials and is used as reference for the modified versions.

### Modified Oligomeric Metal Coordination Complex

### Solution 2

Similar to the above, different ratios of chromium perchlorate and ethylenediamine solution can be used to generate solutions having a different pH such as pH 3.0, 4.0, pH 5.0 or some other pH. For Solution 2, chromium perchlorate hexahydrate (103.5 g) was dissolved into 1000 mL of purified water and mixed thoroughly until all solid dissolved. 8 mL of ethylene diamine solution was added to 1000 mL of purified water and the two solutions were combined by the dropwise addition of EDA solution into the chromium salt solution, and stirred overnight at room temperature, and then left to equilibrate to a pH of approximately 3.0. Lower pH reduces the reactivity of the metal coordination complex.

### Solution 3

In this example, chromium chloride hexahydrate (106.6 gm) was dissolved into 1000 mL of purified water and mixed thoroughly until all solid dissolved. Similarly, 34.8 ml of ethylene diamine solution was added to 1000 mL of purified water. The solutions were combined by the dropwise addition of EDA solution into the chromium salt solution, and stirred overnight at room temperature, and then left to equilibrate to a pH of approximately 3.0.

### Solution 4

In this example, chromium sulphate hexahydrate (39.2 gm) was dissolved into 460 mL of purified water and mixed thoroughly until all solid dissolved. Similarly, 3.6 g of lithium hydroxide was added to 500 mL of purified water and mixed thoroughly until all solid dissolved. The solutions were combined by the dropwise addition of LiOH solution into the chromium salt solution, and stirred overnight at room temperature, and then left to equilibrate to a pH of approximately 3.0.

### Solution 5

As one example, 500 ml 100 mM acetate buffer at pH 3.6 is added dropwise to 500 ml of Solution 3, with stirring, and then left to equilibrate to a pH of approximately 3. Similarly, different excesses of acetate buffer at any nominated pH can be added to the different versions of the complexes formed in Solutions 1, 2, 3 and 4. This provides significant flexibility in the tailoring of the modified oligomeric metal coordination complex being formed.

### Solution 6

As one example, 500 ml 100 mM oxalic buffer at pH 3.5 is added dropwise to 500 ml of Solution 3 with stirring, and then left to equilibrate to a pH of approximately 3.5. Similarly, different excesses of oxalate buffer at any nominated pH can be added to the different versions of the complexes formed in Solutions 1, 2, 3 and 4.

### Solution 7

In this example, 90.5 g of chromium acetate (where the tri-chromium complex has 6 or more acetate groups, such as [Cr₃O(O₂CCH₃)₇(OH)₂]) was dissolved into 3000 mL of purified water and mixed thoroughly until all solid dissolved. The pH of the 50 mM solution was pH 4.2 and could be pH adjusted as required. This example could be considered a fully capped version of Solution 4 giving slower reactivity of the metal complex to binding active materials and polymer binders. However, the reactivity of such metal complexes can be further decreased by the addition of other capping groups such as acetates, oxalates, etc.

### Solution 8

Hydrophobic capping groups can be also used to change the surface properties of a particle and/or complement other particles. By the selection of capping groups, solvent, excess of base and temperature, either hydroxo or oxo interactions can form to further manipulate the off rate of the capping group of the modified metal coordination complex. In this example, 9.3 g (50 mmoles) of 1-naphthalene acetic acid solution in 100 mL of isopropanol was slowly added to finely pulverised potassium hydroxide (4.6 g, 82.5 mmoles) with stirring. The solution was stirred for at least 10 mins at room temperature to form a fine suspension and then chromium perchlorate (51.2 g, 100 mmoles) in 150 mL of isopropanol was added slowly with vigorous mixing. The resultant mixture was heated to reflux for 60 min. After cooling the solution to room temperature, the insoluble potassium salt was filtered off with another 50 mL of isopropanol to form a dark green chromium metal complex.

### Example 2: Binding of Oligomeric Metal Coordination Complexes to Active Material Particles, Particularly to Nanoparticles

Examples of an oligomeric metal coordination complex activating different nanoparticles are described below. Generally, 1 g of the appropriate particle (or nanoparticle) materials was dispersed in 40 ml of one of the above oligomeric metal coordination complex solutions and the mixture sonicated utilizing an ultrasonic probe (Henan Chengyi Laboratory Equipment Co., Ltd, China) for 1 hr at 30% power and 3 s on/off cycle. The mixture is then filtered to dryness and approximately 2.5 mg samples were transferred into 1.5 ml Eppendorf tubes and 1 ml of DI water added. After sonication, 10 μl was extracted and further diluted with 1 ml DI water, vortexed and immediately transferred into a zeta potential cuvette for measurement on a Malvern Nano ZS Zetasizer. The method for producing the controls was the same except 40 ml of DI water was used instead of the oligomeric metal coordination complex solution. In all samples investigated, there was a shift to positive charge in the zeta potential on reaction of nanoparticles with the oligomeric metal coordination complex, thereby indicating successful coordination.

### Particle 1

In this example, silicon nanoparticles (100 nm, SAT nanoTechnology Material Co. Ltd., China) were treated with an oligomeric metal coordination complex solution (Solution 1). The control gave a zeta potential measurement of −39.1 mV indicating that the surface was negatively charged. On treatment with the oligomeric metal coordination complex solution, the zeta potential shifted to +28.2 mV indicating that the surface has changed its charge due to the presence of positively charged oligomeric metal coordination complexes on the silicon nanoparticle surface.

### Particle 2

In this example, carbon (C65) nanoparticles (MTI CORP., USA) were treated with oligomeric metal coordination complex solution (Solution 1). The control gave a zeta potential measurement of −28.6 mV indicating that the surface was negatively charged. On treatment with the oligomeric metal coordination complex solution, the zeta potential shifted to +47.2 mV indicating that the surface has changed its charge due to the presence of positively charged oligomeric metal coordination complexes on the C65 surface.

### Particle 3

In this example, silicon nanoparticles (100 nm, SAT nanoTechnology Material Co. Ltd., China) were treated with oligomeric metal coordination complex solution (Solution 5, acetate capped chromium perchlorate based at pH 3.0). The control gave a zeta potential measurement of −39.1 mV indicating that the surface was negatively charged. On treatment with the oligomeric metal coordination complex solution, the zeta potential shifted to −7.5 mV indicating that the surface has changed its charge due to the presence of positively charged oligomeric metal coordination complexes on the silicon nanoparticle surface.

### Particle 4

In this example, carbon (C65) nanoparticles (MTI CORP., USA) were treated with metal coordination complex solution (Solution 5, acetate capped, chromium perchlorate based, pH 3.0). The Control gave a zeta potential measurement of −28.6 mV indicating that the surface was negatively charged. On treatment with the metal coordination complex solution, the zeta potential shifted to +46.3 mV indicating that the surface has changed its charge due to the presence of positively charged metal coordination complexes on the C65 surface.

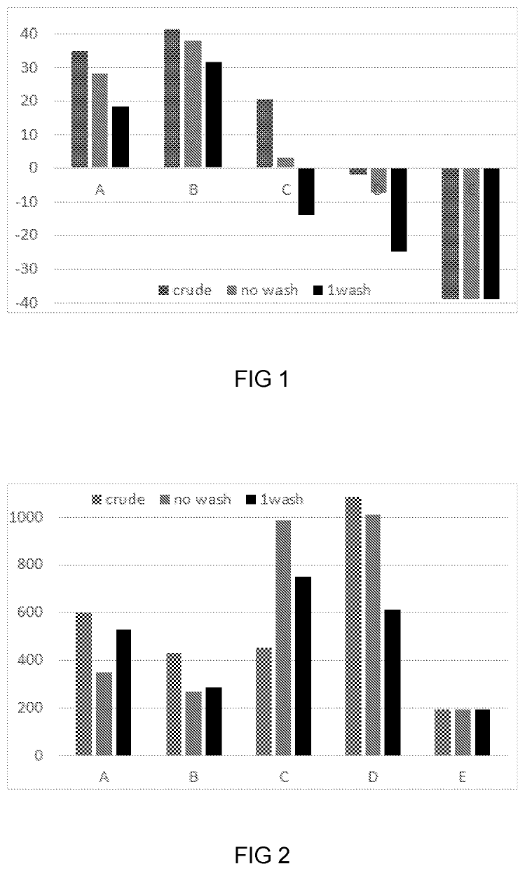

For comparison purposes, the zeta potential and average size of silicon nanoparticles (100 nm, SAT nanoTechnology Material Co. Ltd., China) when treated with different oligomeric metal coordination complex solutions were compared. FIG. 1 shows the zeta potential for silicon activated with chromium perchlorate derived oligomeric metal coordination complexes: A, formed at pH 4.5 per Solution 1; B, acetate capped but formed at pH 4.5; C formed at pH 3.0; D, acetate capped but formed at pH 3.0; and E, water as Control. Each sample was measured as a crude, after filtration and resuspension in water, and after one wash, filtration and resuspension in water. Each type of metal coordination complex gave different charge readings, but all gave some increase towards a positive charge. The results for A showed that the unmodified metal complexes bound strongly to the silicon while the results for B show that similarly strong binding is achieved using acetate capped complexes at the same pH. The results for C exemplify the effect that control over pH can have with the complexes being less strongly bound. This is further the case for D where the effect of washing is even greater on removal of the metal coordination complexes. Nonetheless, all examples have enough metal coordination complexes bound to raise the zeta potential significantly. The results for C and D versus those for A and B indicate that a further level of control can be achieved over the reactivity of the activated nanoparticles by exercising a choice over the pH at which the metal complexes are formed, whether they are additionally capped or not and by choosing the type of capping group used.

FIG. 2 shows the sizes of different activated particles in nanometers: A, formed at pH 4.5 per Solution 1; B, acetate capped but formed at pH 4.5; C formed at pH 3.0; D, acetate capped but formed at pH 3.0; and E, water as Control. As shown, the lower pH versions (C and D) gave a larger particle size distribution, indicative of particle aggregation and cross-linking, which is desirable when forming composite particles of closely associated/interconnected particles (or nanoparticles). In each case, the acetate capped versions when compared to their uncapped analogues gave large clusters indicating pH and capping are providing different characteristics to the basic metal coordination complexes. As discussed, this provides for a useful additional level of control in the present method in that both capping and pH selection can be employed, separately or together, to appropriately modify the reactivity of the oligomeric metal coordination complexes and influence the nature of the activated particles (or nanoparticles) being formed.

### Particle 5

In this example, magnetic nanoparticles (AllRun 200 nm, PM3-020 Lot 2015011501) were treated with different oligomeric metal coordination complex solutions: A, Solution 1 (unmodified); B, acetate capped but formed at pH 2.4 as shown for Solution 5; C, oxalate capped at pH 3.2 as shown for Solution 6; and D, water as Control. For each, 200 μL of stock particles was diluted with 200 μL of water to form a 5 mg/ml suspension, vortexed and bath sonicated for 15 mins to fully disperse the particles. A bead plug was formed using a magnetic separator, and then the supernatant was removed. The particles were resuspended in 400 μL of metal coordination complex solutions (10 mM conc) (and water for the Control) and vortexed, sonicated, and left on a rotator for at least one hour. After repeating vortex and sonication, a sample was diluted 1:100 with water for zeta sizer measurements.

The particles were reacted with 500 μL of 1% solution of polyacrylic acid (100 kD, pH 5.5). After vortex and sonication, the samples were left on a rotator overnight. A bead plug was formed using a magnetic separator, the supernatant removed, and the particles resuspended in 400 μL of water, with repeat vortex and sonication. After repeating this wash step one more time, a sample was diluted 1:100 with water for zeta sizer measurements.

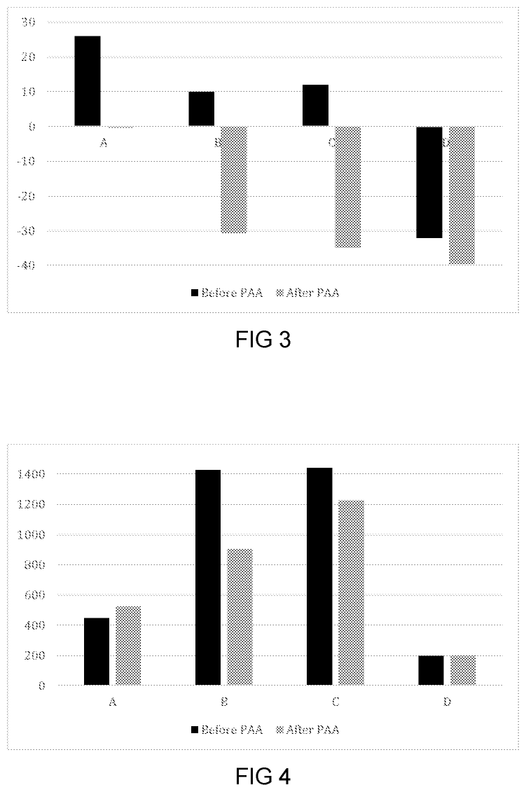

FIGS. 3 and 4 show the zeta potential and sizes of pre- and post-PAA coated particles. Before treatment with polyacrylic acid (PAA) solutions, the particles formed from modified metal coordination complexes (B and C) gave size distribution indicative of the clustering of these magnetic nanoparticles. In this example, the unmodified metal coordination complex (A) shows some dimer formation. The Control (D) gave no change in size or zeta potential. Depending on the particle concentration and the type and concentration of metal coordination complex used, different size clusters of associated/interconnected nanoparticles are formed having a net positive charge due to the metal complex.

After PAA treatment, the modified metal coordination complexes (B and C) formed smaller composites with a net negative change due to the carboxyl anions of the polyacrylic acid (PAA). Weakly associated nanoparticles did not remain within the composite cluster during PAA coating. In this example, the unmodified metal coordination complex (A) shows a small increase in particle diameter due to the PAA layer. The Control (D) gave no change in size or zeta potential. If higher unmodified metal coordination complex to particle ratio is used, dimers were not formed but with lower metal complex to particle ratios, there was uncontrolled aggregation, poor uniformity and weakly associated clusters.

### Example 3: Preparation of Composite Precursor Formulations

Examples of composite precursor formulations for use in silicon based anode applications are described below.

### Precursor Formulation 1.

In this example, a 50 mM (final concentration) oligomeric metal coordination complex (Solution 1) was used. Nano silicon powder (10 gm) and conductive carbon black Super C65 (2.6 gm) were activated together in 600 ml of Solution 1. The suspension of solids was sonicated in an Ultrasonic Processor (Henan Chengyi Laboratory Equipment Co., Ltd, China) at 70% power for 1 hour for better dispersion. The suspension was then filtered through 0.2 nm Nalgene filter and resulting wet cake re-dispersed in 350 ml DI water using a Shear Mixer (IKA T25, Germany). Alginic acid sodium salt from brown algae, medium viscosity (Sigma-Aldrich, Germany) 397 g of 0.65% DI water solution, was added to the re-dispersed activated silicon nanoparticle-C65 suspension under vigorous stirring in a Shear Mixer (IKA T25, Germany). Formulation 1 therefore represents a formulation wherein an unmodified oligomeric metal coordination complex is used to interact with the silicon and carbon active materials in an environment with an alginate polymer.

### Composite Particle Precursor Formulation 2.

In this example, a 50 mM (final concentration) oligomeric metal coordination complex (Solution 5—acetate capped) at pH 2.3 was used. Nano silicon powder (10 gm) and conductive carbon black Super C65 (2.6 gm) were activated together in 600 ml of Solution 5. The suspension of solids was sonicated in an Ultrasonic Processor (Henan Chengyi Laboratory Equipment Co., Ltd, China) at 70% power for 1 hour for better dispersion. The suspension was then filtered through 0.2 nm Nalgene filter and the resulting wet cake re-dispersed in 350 ml DI water using a Shear Mixer (IKA T25, Germany). Alginic acid sodium salt from brown algae, medium viscosity (Sigma-Aldrich, Germany) 397 g of 0.65% DI water solution, was added to the re-dispersed activated silicon nanoparticle-C65 suspension under vigorous stirring in a Shear Mixer (IKA T25, Germany). Formulation 2 therefore represents one formulation of the invention whereby two activated nanoparticle types are formed with a modified oligomeric metal coordination complex in an environment with an alginate polymer.

### Precursor Formulation 3.

In this example, a 50 mM (final concentration) oligomeric metal coordination complex (Solution 1) was used. Nano silicon powder (10 gm) and conductive carbon black Super C65 (2.6 gm) were activated together in 600 ml of Solution 1. The suspension of solids was sonicated in an Ultrasonic Processor (Henan Chengyi Laboratory Equipment Co., Ltd, China) at 70% power for 1 hour for better dispersion. The suspension was then filtered through a 0.2 nm Nalgene filter and the resulting wet cake re-dispersed in 350 ml DI water using a Shear Mixer (IKA T25, Germany). 2% Polyacrylic acid (average MWt 450,000) lithium salt solution, pH4.5 (Sigma-Aldrich, Germany) 136 g was added to the re-dispersed activated silicon nanoparticle-C65 suspension under vigorous stirring in a Shear Mixer (IKA T25, Germany). Formulation 3 therefore represents a formulation wherein an unmodified oligomeric metal coordination complex is used to interact with the silicon and carbon active materials in an environment with a PAA polymer.

### Composite Particle Precursor Formulation 4.

In this example, a 50 mM (final concentration) oligomeric metal coordination complex (Solution 5—acetate capped) at pH 2.3 was used. Nano silicon powder (10 gm) and conductive carbon black Super C65 (2.6 gm) were activated together in 600 ml of Solution 5. The suspension of solids was sonicated in an Ultrasonic Processor (Henan Chengyi Laboratory Equipment Co., Ltd, China) at 70% power for 1 hour for better dispersion. The suspension was then filtered through a 0.2 nm Nalgene filter and the resulting wet cake re-dispersed in 350 ml DI water using a Shear Mixer (IKA T25, Germany). 2% Polyacrylic acid (average MWt 450,000) lithium salt solution, pH4.5 (Sigma-Aldrich, Germany) 136 g was added to the re-dispersed activated silicon nanoparticle-C65 suspension under vigorous stirring in a Shear Mixer (IKA T25, Germany). Formulation 4 therefore represents one formulation of the invention whereby two activated nanoparticle types are formed with a modified oligomeric metal coordination complex in an environment with a PAA polymer.

### Composite Precursor Formulation 5.

In this example, a 50 mM (final concentration) oligomeric metal coordination complex (Solution 5—acetate capped) at pH 2.7 was used. Nano silicon powder (10 gm) and conductive carbon black Super C65 (2.6 gm) were activated together in 600 ml of Solution 5. The suspension of solids was sonicated in an Ultrasonic Processor (Henan Chengyi Laboratory Equipment Co., Ltd, China) at 70% power for 1 hour for better dispersion. The suspension was then filtered through a 0.2 nm Nalgene filter and the resulting wet cake re-dispersed in 700 ml DI water using a Shear Mixer (IKA T25, Germany). 17.4 g of 5% water dispersion NC7000 carbon nanotubes (Nanocyl, Belgium) was added to the suspension under vigorous mixing at 22,000 rpm in a Shear Mixer (IKA T25, Germany). The resulting 900 ml suspension was split into two 450 ml portions and each portion mixed with 295 g of 0.5% Polyacrylic acid (average MWt 450,000) lithium salt solution, pH 4.5 (Sigma-Aldrich, Germany) to the re-dispersed activated silicon nanoparticle-C65 suspension under vigorous stirring in a Shear Mixer (IKA T25, Germany). Formulation 5 therefore represents one formulation of the invention whereby two activated nanoparticle types are formed with a modified oligomeric metal coordination complex in an environment with a PAA polymer, which is at a lower concentration as compared with Formulation 4.

### Example 4: Preparation of Composite Particles for Electrodes

A. The Composite Precursor Formulations formed in Example 3 could be formed into composite particles.

Heating and Evaporation. There are many methods for slow evaporation with heating under agitation to form composite particles. In one example, samples from Example 3 were stirred at 90° C. for 6 hours at 300 rpm until most of the water was evaporated. Microscopic analysis using a Leica DM750 with a camera unit (Leica ICC50HD) showed that the particles easily broke apart with sonication (Bath sonicator—VWR model 142-0082, frequency 35 kHz, power 384 watts). If the composite particles were left to dry overnight in a 60° C. oven and then reconstituted back into water, the particles were more stable. Even so, composite particles formed using Solution 5 (modified metal complex, acetate capped at pH 2.4) were far more stable than those formed from Solution 1 (unmodified). Heating and removal of water increased composite particle stability.

Spray Drying: To form particles, the suspension of the relevant composite precursor formulation is stirred for 15 min at 25,000 rpm and spray dried using a laboratory spray dryer (Buchi-290, Switzerland) using the following settings: Inlet temperature 210° C.; Gas flow 35 mm; Aspirator 100%; Feed rate 50%. The resulting dried composite particles were collected and used for fabrication of electrodes.

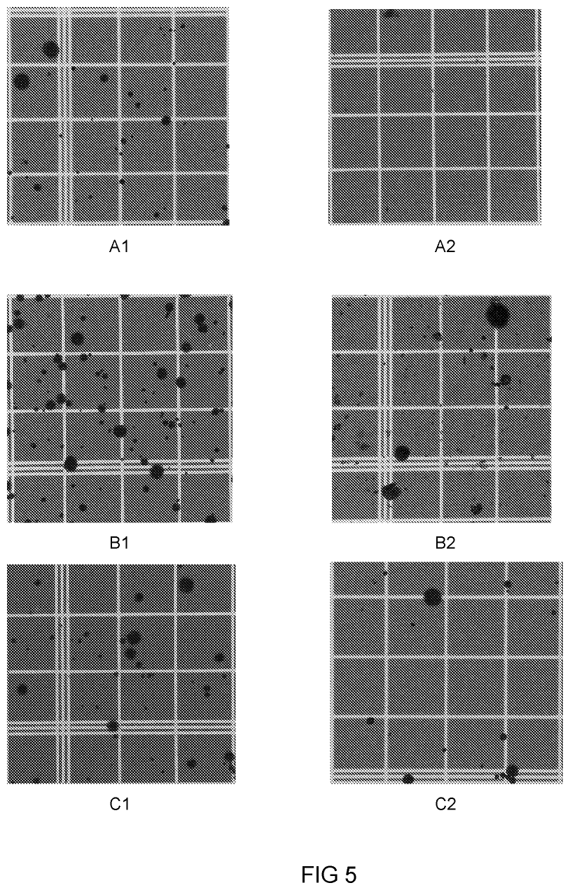

Some of the spray dried particles were also resuspended in water and sonicated to assess general stability. FIG. 5 shows pictures of spray dried particles formed using metal complexes A, Solution 1 (unmodified); B, Solution 5 (acetate capped, pH 2.4; C, Solution 7 (chromium acetate, pH 4.2) before (1) and after (2) sonication. Before sonication, the spray dried particles look similar but after 45 mins sonication, the spray dried particles formed from Solution 1 (Composite Precursor Formulation 3) had broken up indicating poor integrity of the spray dried particles. In contrast, the spray dried particles formed from Solution 5 (Composite Precursor Formulation 4) and those from Solution 7 (Composite Precursor Formulation 6) had not broken up under the same conditions by microscopic analysis.

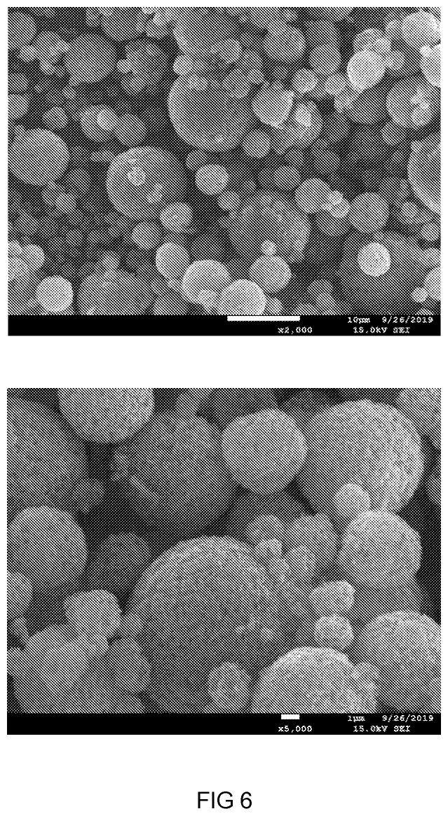

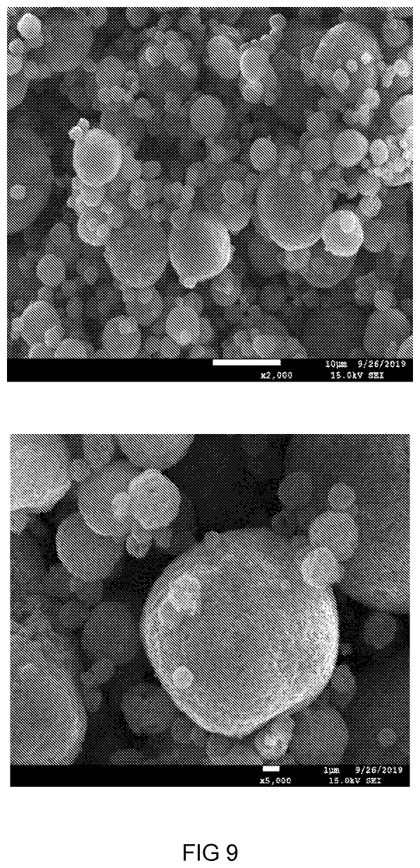

SEM data also show no visual difference between the spray dried particles formed using unmodified vs modified metal complexes. FIG. 6 shows two SEM images, at different magnifications, of composite particles formed from Composite Precursor Formulation 3 (using unmodified metal complex) after spray drying. While the SEM images show that solids have been formed, as will be discussed below, they are not composite particles of the present invention. FIG. 9 shows two SEM images (using JEOL 7001F), at different magnifications, of composite particles formed from Composite Precursor Formulation 4 after spray drying (as described above). The SEM images clearly show that discrete composite particles had been formed.
B. The composite particles were used to prepare slurries.

Firstly 0.7 g of carboxymethyl cellulose (CMC, 400,000 g/mol) sourced from MTI is hydrated in 35 g of water using a shear mixer, then 1.6 g of C65 is added to the CMC solution and dispersed with the shear mixer. This was followed by the addition of the Silicon-based composite particle formed from the Precursor Composite Formulations in Example 3 and dispersed with an overhead mixer (Dispermat). 20 g of natural graphite is then mixed using the dispermat, and finally 0.4 g of styrene butadiene rubber (SBR) sourced from MTI is added to the mixture and mixed for the next 10 min.

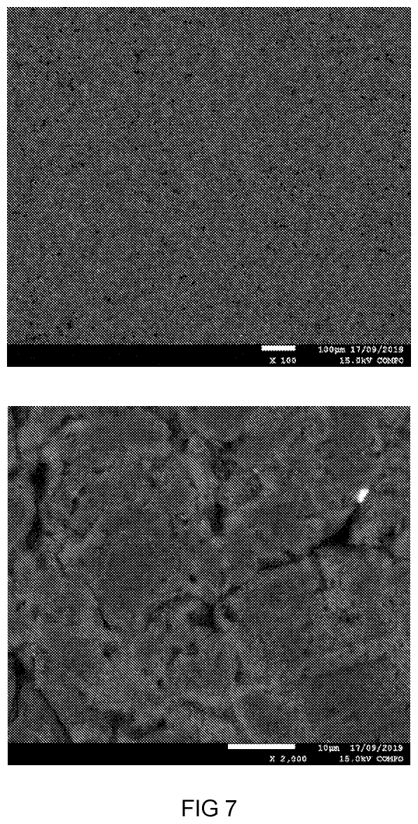

FIG. 7 shows SEM images representing the composite particles of FIG. 6 (formed by spray drying of precursor Formulation 3) after slurry preparation and casting onto copper foil. The particles of FIG. 6 are seen, in FIG. 7, to have degraded under anode fabrication conditions. Essentially, the particles formed using unmodified oligomeric metal coordination complexes simply break apart during mixing under aqueous conditions and so any discrete particles which may have existed are destroyed. This data, as well as the sonication experiments above, clearly shows that such methods using unmodified oligomeric metal coordination complexes cannot form highly interconnected composite particles as defined herein.

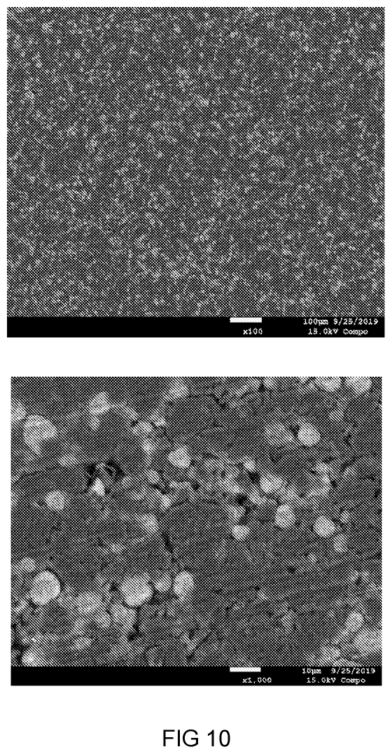

In contrast, FIG. 10 shows SEM images representing the composite particles of FIG. 9 (formed by spray drying of composite particle precursor Formulation 4) after slurry preparation and casting onto copper foil. Unlike the particles as shown in FIG. 7, the particles of FIG. 9 are seen, in FIG. 10, to be clearly more stable under anode fabrication conditions allowing for their incorporation into anode materials. This data, as well as the sonication experiments above, clearly shows that methods of the present invention using modified oligomeric metal coordination complexes are able form stable highly interconnected composite particles, as defined herein, which are suitable for subsequent use in anode formation. The contrast with the approach visualised in FIG. 7.
C. Electrode and coin cell fabrication.

The slurries were casted onto copper foil, as described above, and then dried under vacuum, calendared and cut for coin cell assembly. Lithium (Li) metal was used as the counter electrode, and 1M LiPF₆ in ethylene carbonate (EC)/ethyl-methyl carbonate (EMC)/diethyl carbonate (DEC) (3/5/2 vol %)+1 wt % vinylene carbonate (VC)+10 wt % fluoroethylene carbonate (FEC) was used as electrolyte for the coin cell assembly. For charge/discharge cycling tests, the coin cells were activated at 0.01 C (1 C=4,200 mAh/g) for 2 cycles and then cycled at 0.5 C (1 C=4,200 mAh/g) for long-term stability testing. The C rates were based on the mass of active material (Si particles, graphite) in the electrodes. The voltage range for charge/discharge tests was 0.005-1.50 V vs. Li. The charge/discharge tests were conducted on Neware multi-channel battery testers controlled by a computer. Three replicate cells were made and tested for each condition.

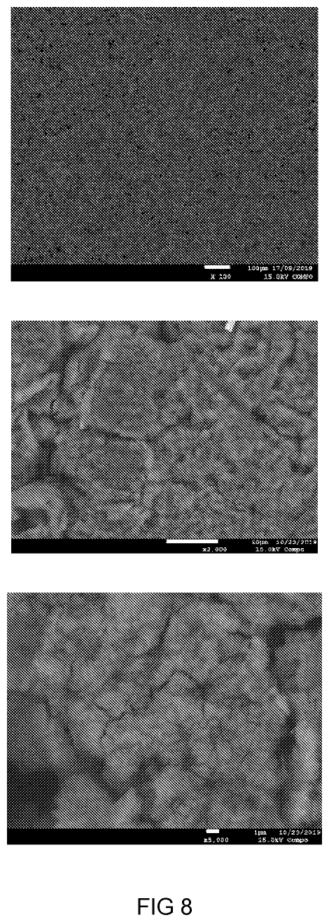

Representative SEM images were obtained and FIG. 8 shows SEM images, at different magnifications, of the solids formed in Example 3 using Precursor Formulation 3 after coin cell assembly and cycling. FIG. 8 therefore represents the outcome of the use of the solids of FIG. 6 incorporated into the slurry shown in FIG. 7 and now incorporated into a coin assembly and exposed to charge cycles. FIG. 7 already showed significant degradation of the solids of FIG. 6 and so it is no surprise that FIG. 8 indicates the particles have degraded even further under coin cell assembly and cycling conditions. While an electrode formed directly from the slurry of composite precursor formulation 3 may be appropriate for use, as described in the applicant's earlier patent publications, this clearly indicates that such a formulation is not appropriate for formation of discrete particles which are then to be used for electrode formation. The solids formed are simply not physically robust enough which clearly indicates that an interconnected network of nanoparticle, oligomeric metal coordination complex, and polymer is not being formed and so the electrical performance would also be suboptimal.

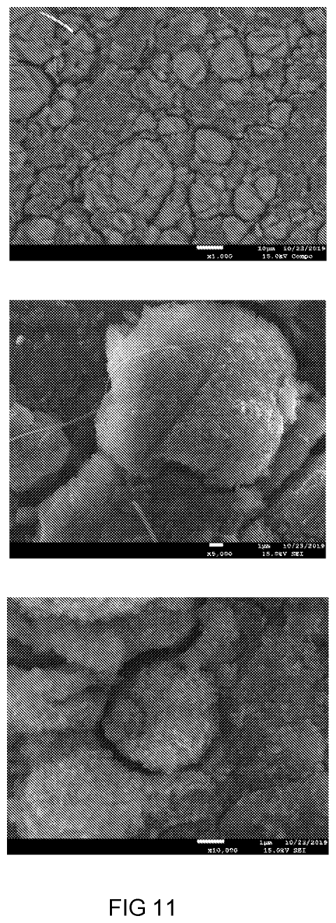

FIG. 11 shows SEM images, at different magnifications, of the composite particles formed in Example 3 using Composite Particle Precursor Formulation 4 after coin cell assembly and cycling. FIG. 11 therefore represents the outcome of the use of the composite particles of FIG. 9 incorporated into the slurry shown in FIG. 10 and now incorporated into a coin assembly and exposed to charge cycles. The discrete composite particles are still observable in FIG. 11 indicating the composite particles have maintained their structure under coin cell assembly and cycling conditions. Precursor formulation 4 employed capping groups to create a modified oligomeric metal coordination complex for formation of activated nanoparticles and subsequent composite particle formation. The images of FIGS. 9, 10 and 11 show that this results in discrete particles which are robust enough to withstand slurry mixing, electrode formation, incorporation into a coin assembly and, importantly, actual charge and discharge cycles. The difference achieve by the use of such modified complexes is therefore clear.

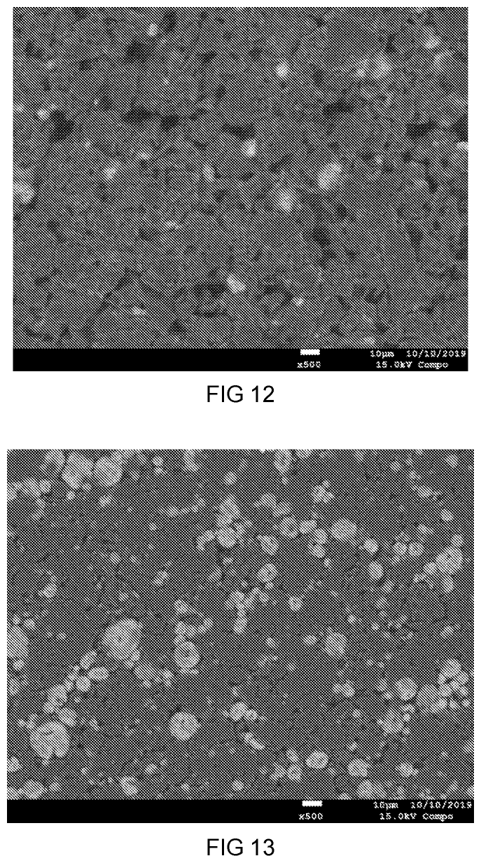

For further comparison of the different experimental outcomes achieved, FIG. 12 shows an SEM image of solids formed in Example 3 using Precursor Formulation 1 after slurry preparation and casting onto copper foil. The solids have already started disintegrating after electrode slurry processing indicating poor mechanical properties obtained from alginate polymer with unmodified metal complexes (Solution 1, uncapped chromium perchlorate at pH 4.5) as cross-linker between nanoparticles and polymer.

FIG. 13, by way of comparison, shows an SEM image of composite particles of the invention formed in Example 3 using Composite Particle Precursor Formulation 2 after slurry preparation and casting onto copper foil. Composite particles obtained from an alginate polymer with capped oligomeric metal coordination complexes (Solution 5, acetate capped chromium perchlorate at pH2.3) as cross-linker have clearly remained mechanically stable during electrode slurry processing. It will be appreciated that the difference between the solids shown in FIG. 12, when compared to the particles of FIG. 13, is the use of capped, pH adjusted (modified) oligomeric metal coordination complexes in their formation acting as a cross-linker between nanoparticles and polymer.

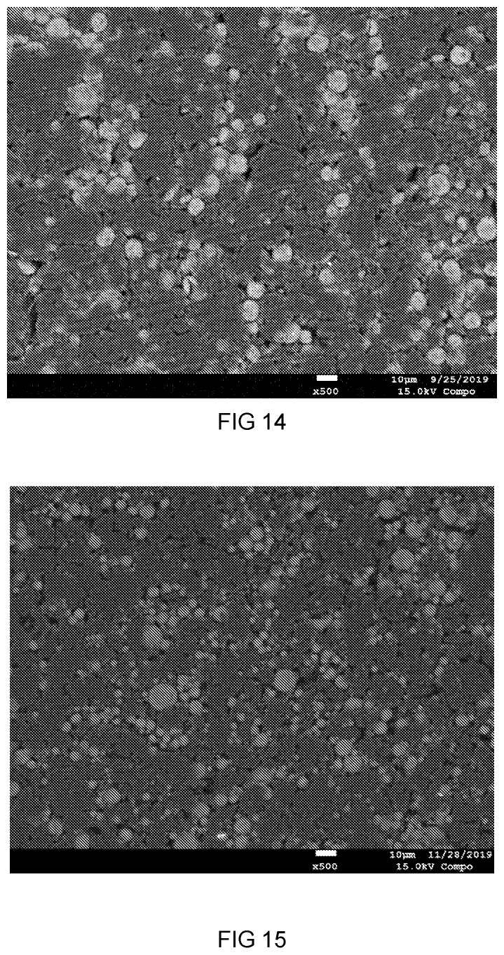

FIG. 14 shows an SEM image of stable composite particles of the invention formed in Example 3 using Composite Particle Precursor Formulation 4 after slurry preparation and casting onto copper foil.

FIG. 15 shows an SEM image of composite particles of the invention formed in Example 3 using Composite Particle Precursor Formulation 5 after slurry preparation and casting onto copper foil. Composite particles obtained from PAA polymer with capped oligomeric metal coordination complexes (Solution 5, acetate capped chromium perchlorate at pH2.3) as cross-linker have clearly remained mechanically stable during electrode slurry processing. By comparison to FIG. 14, 0.5% PAA polymer binder was used and more carbon nanotubes were added as conductive aid. The results indicate that stable composite particles could be formed.

### Example 5: Preparation of Porous Composite Precursor Formulations

### A. Porous Composite Precursor Formulations.

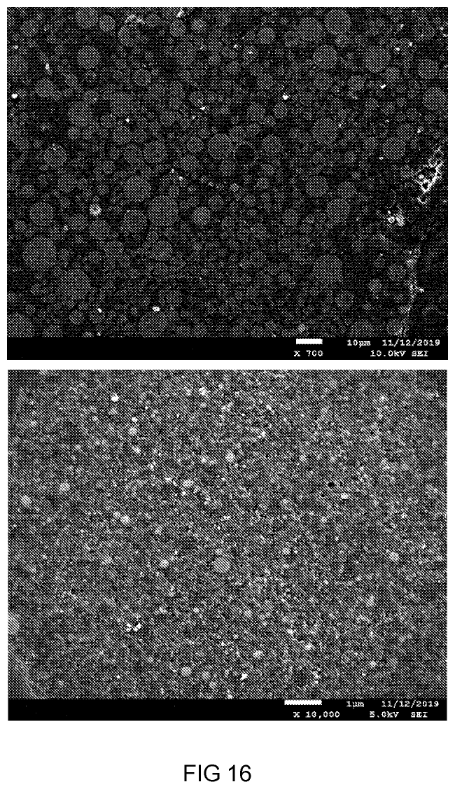

In this example, oligomeric metal coordination complex (Solution 5 at pH 3.0) was used in a similar process to Composite Precursor Formulation 4 in Example 3 except 5% water dispersion carbon nanotubes (NC7000, Nanocyl, Belgium) was included. To assess the porous structure of spray dried particles, the particles were mixed with epoxy resin and left to set overnight in a mould. The stub was ground and polished to reveal cross sections of the particles. The cross section reveals porous structure and even distribution of the silicon-based composite particle components. FIG. 16 shows SEM images of the cross section of these stable composite particles. These particles were used to prepare slurries as previously described and cast onto copper foil. SEM images which confirms particle stability under anode fabrication conditions are shown in FIGS. 9 to 11.

### B. Porous Composite Precursor Formulation 6 (Using Porogens).

In this example, a 50 mM (final concentration) oligomeric metal coordination complex (Solution 7 at pH 4.2) was used. Nano silicon powder (10 g) and conductive carbon black Super C65 (2.79 g) were activated together in 600 ml of Solution 7. The suspension of solids was sonicated in an Ultrasonic Processor (Henan Chengyi Laboratory Equipment Co., Ltd, China) at 70% power for 1 hour for better dispersion. The suspension was then filtered through a 0.2 nm Nalgene filter and the resulting wet cake re-dispersed in 300 ml DI water using a Shear Mixer (IKA T25, Germany). 16.4 g of 5 wt % water dispersion NC7000 carbon nanotubes (Nanocyl, Belgium) was added to the suspension under vigorous mixing at 22,000 rpm in a Shear Mixer (IKA T25, Germany) resulting in 400 ml suspension. The suspension was mixed with 49.33 g of 5.65% Polyacrylic acid (average MWt 450,000) lithium salt solution, pH 4.5 (Sigma-Aldrich, Germany), diluted to 300 ml. 120 ml of 2-Propanol (Sigma-Aldrich, Germany) 15% in aqueous suspension were added to the 700 ml re-dispersed activated silicon nanoparticle-C65 suspension under vigorous stirring in a Shear Mixer (IKA T25, Germany). This Formulation 6 therefore represents one formulation of the invention whereby a modified oligomeric metal complex (Solution 7) is used with isopropanol (one porogen) to assess particle stability and pore formation within composite particles. After spray drying under compressed nitrogen, mercury porosimetry (AutoPore IV9500 V1.9, Particle and Surface Sciences Pty, Ltd, Australia) on these composite particles show interstitial porosity of 47% and particle porosity of 29%. Further data on these composite particles is provided in the Table below.

| | |
|---|---|
| Single point surface area at P/Po = 0.2508 (m2/g) | 43.51 |
| BET Surface area (m2/g) | 45.43 |
| Langmuir Surface area (m2/g) | 60.83 |
| Single point adsorption total pore volume of pores less | 0.2767 |
| than 135.0 nm width at P/Po = 0.9855 (cm³/g) | |
| Adsorption average pore width (4 V/A by BET) (nm) | 24.36 |
| Resulted Particle size D₁₀, D₅₀, D₉₀ (μm) | 2.79, 8.81, 19.9 |
| Porosity (%) | 76.7 |
| Interstitial porosity (%) | 47.63 |
| Particle Porosity (%) (average) | (29.07) |

To prepare slurries, 0.55 g of carboxymethyl cellulose (CMC, 400,000 g/mol) sourced from MTI was hydrated in 32 g of water using a shear mixer, then 0.55 g of C65 is added to the CMC solution and dispersed with the shear mixer. This was followed by the addition of 3.96 g silicon-based composite particle formed from the Precursor Composite Formulation 6 (above) and dispersed with an overhead mixer (Dispermat). 16.39 g of artificial graphite is then mixed using the dispermat, and finally 1.1 g of styrene butadiene rubber (SBR) sourced from MTI was added to the mixture and mixed for the next 10 min.

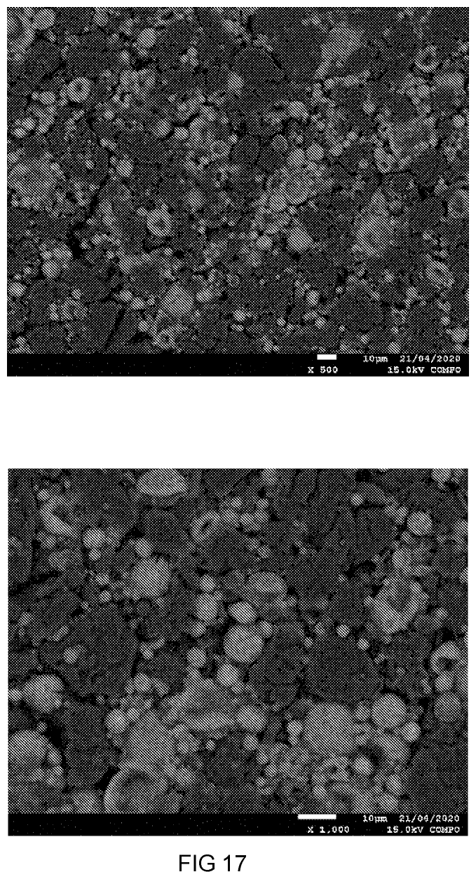

FIG. 17 shows SEM images of stable composite particles formed using modified oligomeric metal complex (Solution 7) after slurry preparation and casting onto copper foil. The use of a porogen such as isopropanol did not affect particle stability after slurry preparation and casting on copper foil.

### Example 6. Order of Addition

In one example, the oligomeric metal coordination complex (Solution 7 at pH 4.00, 600 ml) was used to first mix and activate nanosilicon powder (12.25 g) and conductive carbon black Super C65 (3.41 g). The suspension of solids was sonicated, filtered and redispersed in 700 ml DI water as previously described, and then followed by addition of 20.08 g of 5 wt % water dispersion NC7000 carbon nanotubes (Nanocyl, Belgium) and 97.4 g of 3.5% Polyacrylic acid (average MWt 450,000) lithium salt solution, pH 4.7 (Sigma-Aldrich, Germany). This precursor formulation was spray dried as previously described (but under compressed air).

In an alternative example, the oligomeric metal coordination complex (Solution 7 at pH 4.00) was added last. First, an equivalent amount (30.8 g) of 5 wt % water dispersion NC7000 carbon nanotubes was suspended in 500 mL of DI water and mixed with conductive carbon black Super C65 (5.24 g) in magnetic Stirrer-IKA. 149.7 g of 3.5% Polyacrylic acid (average 450,000 mwt) lithium salt solution, pH 4.7 (Sigma-Aldrich, Germany) was diluted to 400 mL and then mixed with nano silicon powder (18.8 g) in a Shear Mixer. 17.8 ml of a 200 mM (final concentration) of oligomeric metal coordination complex (Solution 7 at pH 4.00) was added and mixed to the final suspension and spray dried as previously described (under compressed air).

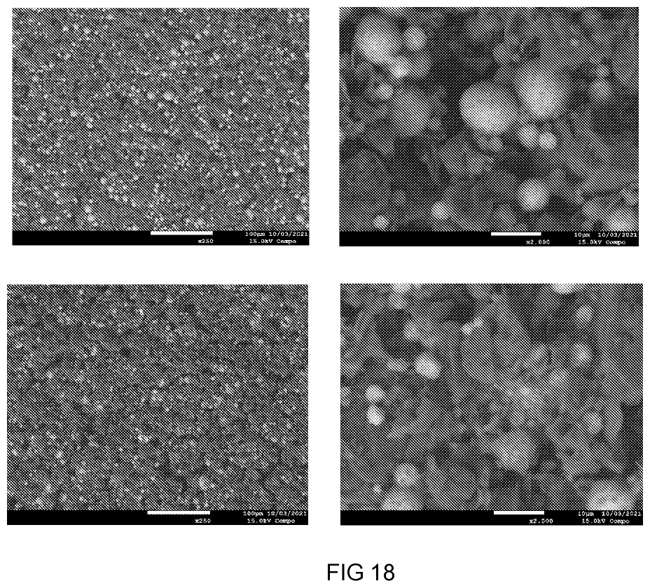

To form slurries, C65 was added to the CMC solution, dispersed with the shear mixer and followed by the addition of composite particles, as previously described. Artificial graphite was then mixed and finally styrene butadiene rubber (SBR) (0.75 g CMC (400,000 g/mol), hydrated in 39.55 g water using a shear mixer, followed by addition of 3.93 g composite particle, and 24.12 g artificial graphite was mixed using the dispermat, and finally 0.9 g styrene butadiene rubber was added). These slurries were cast onto copper foil. FIG. 18 (Top) show SEM images of composite particles formed using precursor formulation where the oligomeric metal complex is first combined with nanosilicon and Super C65. FIG. 18 (Bottom) show SEM images of composite particles formed using precursor formulation where the oligomeric metal complex is the last additive before casting onto copper foil. Both particles maintain mechanical stability during slurry preparation and performed similarly.

### Example 7. Electrochemical Data

In this example, composite particles from Composite Precursor Formulation 4 in Example 3 was used. The composite particles (FIG. 9) were used to prepare slurries, cast onto copper foil (FIG. 10), then calendared, cut dried up to 110° C., under vacuum for coin cell assembly. Lithium (Li) metal was used as the counter electrode, and 1M LiPF₆ in ethylene carbonate (EC)/ethyl-methyl carbonate (EMC)/diethyl carbonate (DEC) (3/5/2 vol %)+1 wt % vinylene carbonate (VC)+10 wt % fluoroethylene carbonate (FEC) was used as electrolyte for the coin cell assembly. For charge/discharge cycling tests, the coin cells were activated at 0.01 C (1 C=4,200 mAh/g) for 2 cycles and then cycled at 0.5 C (1 C=4,200 mAh/g) for long-term stability testing. The C rates were based on the mass of active material (Si particles, graphite) in the electrodes. The voltage range for charge/discharge tests was 0.005-1.50 V vs. Li. The charge/discharge tests were conducted on Neware multi-channel battery testers controlled by a computer. Three replicate cells were made and tested for each condition.

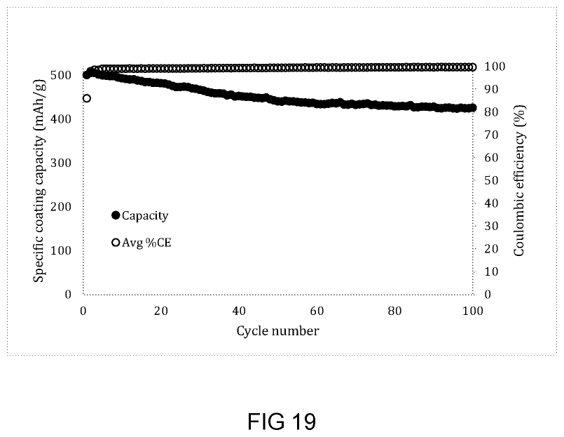

Example of electrochemical data of stability testing after 100 cycle of charge and discharge of the fabricated half coin cell at 0.5 C (1 C=4,200 mAh/g) is shown in FIG. 19. The electrochemical cycling data shows a relatively high initial CE of 86% and starting capacity of 500 mAh/g. These cells showed a stable cycling performance after 50 cycles with a capacity retention of ˜84% after 100 cycles. SEM images are shown in FIG. 11.

1. A method of forming a composite particle including the step of: contacting an active material particle, a modified oligomeric metal coordination complex, and at least one polymer, to thereby form a composite particle.

2. The method of claim 1, wherein the method of forming a composite particle includes the steps of:
(i) mixing an active material particle, a modified oligomeric metal coordination complex, at least one polymer and a liquid carrier to provide a mixed solution; and
(ii) at least partially removing the liquid carrier from the mixed solution;
to thereby form a composite particle.

3. The method of claim 2, wherein the step of at least partially removing the liquid carrier from the mixed solution comprises spray drying, rotary evaporation or evaporation with heating under stirring.

4. The method of claim 1, wherein the method of forming a composite particle includes the steps of:
(i) providing a plurality of activated particles comprising active material particles at least partially coated with a modified oligomeric metal coordination complex; and
(ii) contacting the plurality of activated particles with at least one polymer capable of forming coordinate bonds with the modified oligomeric metal coordination complex,
to thereby form a composite particle.

5. The method of any one of the preceding claims wherein the method further includes the step of controlling the reaction pH and/or temperature and/or mixing and/or relative concentrations of active material particle and/or modified oligomeric metal coordination complex and/or polymer, when the three components are exposed to one another.

6. The method of any one of the preceding claims wherein the method further comprises the step of forming a modified oligomeric metal coordination complex.

7. The method of any one of the preceding claims wherein the method further comprises the step of contacting the activated particles and the at least one polymer, with a liquid and/or solid porogen.

8. A composite particle precursor formulation comprising:
(i) a plurality of activated particles comprising active material particles at least partially coated with a modified oligomeric metal coordination complex;
(ii) at least one polymer capable of forming coordinate bonds with the modified oligomeric metal coordination complex; and
(iii) a liquid carrier in which the plurality of activated particles and at least one polymer are located.

9. The method or composite particle precursor formulation of any one of the preceding claims wherein the at least one modified metal coordination complex is a capped metal coordination complex and/or a metal coordination complex formed at a pH below 3.8.

10. The method or composite particle precursor formulation of claim 9 wherein the capping group used to form the capped metal coordination complex is selected from those including one or more of nitrogen, oxygen, or sulphur as dative bond forming groups.

11. The method or composite particle precursor formulation of claim 10 wherein the capping group is selected from the group consisting of formate, acetate, propionate, oxalate, malonate, succinate, maleate, sulphate, phosphate, and hydroxyacetate.

12. The method or composite particle precursor formulation of claim 9 wherein the at least one modified oligomeric metal coordination complex has been modified by formation at a pH below 3.8.

13. The method or composite particle precursor formulation of any one of the preceding claims wherein the metal ion of the oligomeric metal coordination complex is selected from the group consisting of chromium, ruthenium, iron, cobalt, titanium, aluminium, zirconium, rhodium and combinations thereof.

14. The method or composite particle precursor formulation of any one of the preceding claims wherein the surface of the active material includes a nitrogen, oxygen, sulfur, hydroxyl, or carboxylic acid species.

15. The method or composite particle precursor formulation of any one of the preceding claims wherein the active material particles are selected from the group consisting of metals, intermetallic compounds, metalloids, metal oxides, clays, carbon-based particles, and ceramics.

16. The method or composite particle precursor formulation of any one of the preceding claims wherein the active material is selected from silicon, silicon containing materials (its oxides, composites and alloys), tin, a tin containing material (its oxides, composites and alloys), germanium, germanium containing material (its oxides, composites and alloys), carbon, and graphite.

17. The method or composite particle precursor formulation of any one of the preceding claims wherein the active material is selected from the group consisting of: sulphur, LiFePO₄ (LFP), mixed metal oxides which include cobalt, lithium, nickel, iron and/or manganese, phosphorus, aluminum, titanium and carbon.

18. The method or composite particle precursor formulation of any one of the preceding claims wherein the composite particles have an average particle diameter of less than about 10,000 nm.

19. The method or composite particle precursor formulation of any one of the preceding claims wherein the active material particles are active material nanoparticles and the activated particles are activated nanoparticles.

20. A composite particle comprising a plurality of active material particles, a polymeric network and a plurality of oligomeric metal coordination complexes coordinately bonded to the active material particles and the polymeric network, wherein the majority of at least one active material particle is linked to the polymeric network by one or more of the plurality of oligomeric metal coordination complexes.

21. The composite particle of claim 20 wherein majority refers to at least 50%, 60%, 70%, 80%, 90% or 95% of at least one active material particle type being linked through at least one coordination bond to at least one polymer of the composite particle.

22. The composite material of claim 20 wherein the composite material is selected from a charge collector substrate, an electrode material, and a separator material for a battery application.

23. A composite material comprising a plurality of composite particles of claim 20 and/or a plurality of composite particles formed by the method of claim 1 and/or a plurality of composite particles formed from the composite particle precursor formulation of claim 8.

24. An electrochemical cell including: an anode, a cathode, and an electrolyte arranged between the anode and the cathode; wherein at least one of the anode or the cathode comprises a plurality of composite particles of claim 20 and/or a plurality of composite particles formed by the method of claim 1 and/or a plurality of composite particles formed from the composite particle precursor formulation of claim 8.
